(19) United States
(12) Patent Application Publication
(10) Pub. No.: US 2010/0191567 A1
(43) Pub. Date: Jul. 29, 2010

(54) METHOD AND APPARATUS FOR ANALYZING RHETORICAL CONTENT

(75) Inventors: Yeow Loong Lee, St. Louis, MO (US); John Neil Cobb, Plano, TX (US); John Starnes Moseley, St. Louis, MO (US); Brian Robert Knobbe, St. Louis, MO (US); Kenneth Michael Schulte, Waterloo, IL (US)

Correspondence Address: AT&T Legal Department - GMG;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/420,454

(22) Filed: Apr. 8, 2009

Related U.S. Application Data
(60) Provisional application No. 61/147,440, filed on Jan. 26, 2009.

(51) Int. Cl. G06Q 10/00; G06F 17/30

(52) U.S. Cl. 705/9; 706/46; 707/E17.008; 707/E17.044; 715/234; 705/8; 715/255

(57) ABSTRACT

A system that incorporates teachings of the present disclosure may include, for example, a server, having a controller to deconstruct a document into a plurality of combinations of rhetorical and structural elements associated with at least one rhetorical topic library, and apply a project management procedure to the plurality of combinations of rhetorical and structural elements associated with the rhetorical topic library. Other embodiments are disclosed.

### RELATED APPLICATIONS

This application claims priority to U.S. Provisional Application Ser. No. 61/147,440 filed on Jan. 26, 2009, the disclosure of which is hereby incorporated by reference.

This Application is related to U.S. patent application Ser. No. 10/635,419 filed on Aug. 6, 2003, by Cobb et al., entitled “RHETORICAL CONTENT MANAGEMENT SYSTEM AND METHODS”, the disclosure of which is hereby incorporated by reference herein.

This Application is related to U.S. patent application Ser. No. 10/806,047 filed on Mar. 22, 2004, by Cobb et al., entitled “RHETORICAL CONTENT MANAGEMENT WITH TONE AND AUDIENCE PROFILES”, the disclosure of which is hereby incorporated by reference herein.

This Application is related to U.S. patent application Ser. No. 11/230,015, filed Sep. 19, 2005, by Allan et al., entitled “DATABASE STRUCTURE AND METHOD”, the disclosure of which is hereby incorporated by reference herein.

This Application is related to U.S. patent application Ser. No. 11/299,507, filed Dec. 12, 2005, by Cobb et al., entitled “METHOD FOR CONSTRUCTING AND REPURPOSING RHETORICAL CONTENT”, the disclosure of which is hereby incorporated by reference herein.

This Application is related to U.S. patent application Ser. No. 11/299,503, filed Dec. 12, 2005, by Rege et al., entitled “METHOD FOR DECONSTRUCTING AND REPURPOSING RHETORICAL CONTENT”, the disclosure of which is hereby incorporated by reference herein.

### FIELD OF THE DISCLOSURE

The present disclosure relates generally to content management systems, and more specifically to a method and apparatus for analyzing rhetorical content.

### BACKGROUND

Documents and displayable media such as advertising materials contain “content.” Different content has different purposes, different formats, and different subject matter. Content that has meaning and purpose is typically referred to as rhetorical content.

Most businesses strive to provide a consistent image for all media materials. Content management may be useful, for example, in providing a consistent product description in advertising materials across multiple sales and marketing mediums such as websites, proposals, brochures, and other documents.

Managing content can be a significant challenge for businesses, creating significant costs for larce multi-department organizations. Content reuse issues are made more difficult by variances in regional product availability, audience type, and target marketing. Thus, reoccurring creation and delivery of high quality content to customers and clients is often inefficient and expensive.

As such, expenses increase as content is manually adapted or edited for various uses and formats. It can be difficult for business and organizations to efficiently create content that is consistent, accurate, and readily available for reuse. Especially when so much content already exists and is in a format not conducive to repurposing.

### BRIEF DESCRIPTION OF THE DRAWINGS

FIG. 1 depicts an exemplary embodiment of a rhetorical library with unpopulated variables of rhetorical topics;

FIG. 2 depicts an exemplary embodiment for populating variables in the rhetorical library;

FIG. 3 depicts an exemplary supplemental embodiment of rhetorical topics;

FIG. 4 depicts an exemplary embodiment of a content management system (CMS) for analyzing, deconstructing, reconstructing, and repurposing rhetorical content;

FIG. 5 depicts an exemplary embodiment of the CMS for repurposing the deconstructed rhetorical content;

FIG. 6 depicts an exemplary embodiment of the CMS operating in a communication system;

FIG. 7 depicts an exemplary method operating in the CMS for analyzing, deconstructing, and reconstructing rhetorical content;

FIG. 8 depicts an exemplary method operating in the CMS for repurposing reconstructed rhetorical content;

FIG. 9 depicts an exemplary method operating in the CMS for analyzing, deconstructing, and reconstructing rhetorical content for project management and RFP responses;

FIGS. 10-48 depict graphical user interfaces that can be utilized with the methods of FIGS. 7-9; and

FIG. 49 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method for analyzing, deconstructing, reconstructing, and repurposing rhetorical content.

One embodiment of the present disclosure can entail, a computer-readable storage medium having computer instructions to retrieve a document comprising content corresponding to a questionnaire, deconstruct the content in the document into a plurality of rhetorical content sections, associate at least one rhetorical topic library with the content of each rhetorical content section according to a purpose of the purpose, parse the content of each rhetorical content section into a combination of one or more rhetorical and structural elements according to the at least one rhetorical topic library associated with said content, assign at least one combination of the one or more rhetorical and structural elements to at least one of a plurality of agents, continue the foregoing assignment until all combinations of the one or more rhetorical and structural elements have been assigned to at least one agent where each agent is assigned to respond to the assigned combination, manage the plurality of assignments as a project according to a project management procedure, detect completion of at least one objective of the project according to the project management procedure, and reconstruct the document according to responses provided by each agent associated with a corresponding combination of the one or more rhetorical and structural elements responsive to detecting the completion of the at least one objective.

Another embodiment of the present disclosure can entail, a method including deconstructing content in a document into a plurality of rhetorical content sections, associating at least one rhetorical topic library with the content of each rhetorical content section according to the content's purpose, parsing the content of each rhetorical content section into a combination of one or more rhetorical and structural elements according to the at least one rhetorical topic library associated with said content, assigning at least one combination of the one or more rhetorical and structural elements to at least one of a plurality of agents, continue the foregoing assignment until all combinations of the one or more rhetorical and structural elements have been assigned to at least one agent, where each agent is assigned to respond to the assigned combination, and managing the plurality of assignments as a project according to a project management procedure.

Another embodiment of the present disclosure can entail, a method including applying a project management procedure using a computing device to deconstructed content comprising a plurality of combinations of rhetorical and structural elements associated with at least one rhetorical topic library.

Another embodiment of the present disclosure can entail, a server having a controller to deconstruct a document into a plurality of combinations of rhetorical and structural elements associated with at least one rhetorical topic library, and apply a project management procedure to the plurality of combinations of rhetorical and structural elements associated with the rhetorical topic library.

Another embodiment of the present disclosure can entail, a computer-readable storage medium including computer instructions to retrieve a first document comprising content corresponding to a Request For Proposal (RFP), deconstruct the content into a plurality of rhetorical content sections, associate at least one rhetorical topic library with the content of each rhetorical content section according to a purpose of the content, parse the content of each rhetorical content section into a combination of one or more rhetorical and structural elements according to the at least one rhetorical topic library associated with said content, and retrieve one or more second documents comprising other content associated with a second RFP, where the second documents are retrieved based on a comparison of the parsed content with the other content associated with the second RFP.

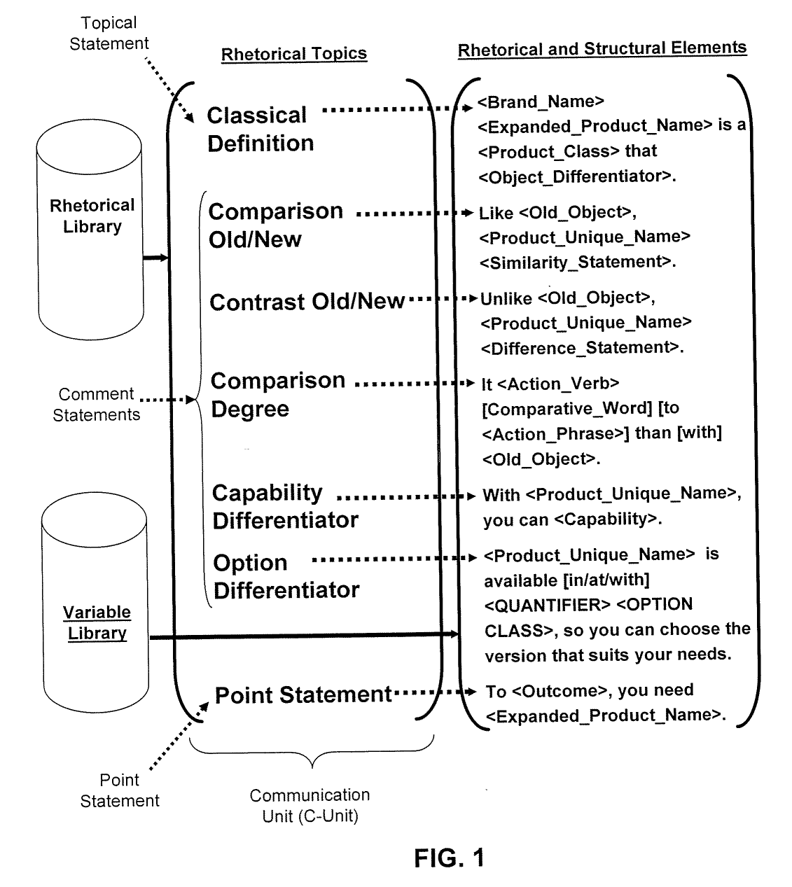

FIG. 1 depicts an exemplary embodiment of a rhetorical library with unpopulated variables of rhetorical topics. The rhetorical topics shown by way of example in FIG. 1 include a classical definition, a comparison between old and new, a contrast between old and new, a comparison as a matter of degree, a capability differentiator, an option differentiator, and a point statement. Each of these rhetorical topics can be subdivided into variable building blocks referred to as rhetorical and structural elements.

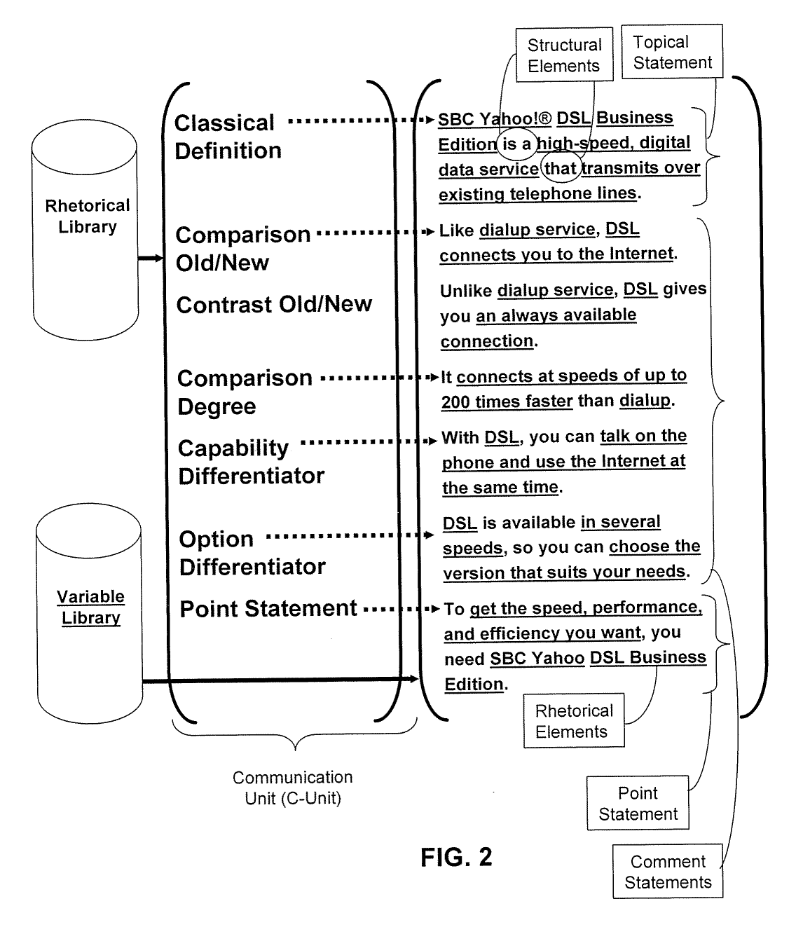

Rhetorical elements express ideas, while structural elements serve to combine ideas coherently to convey as clearly as possible a message to an audience. The rhetorical elements depicted with angle brackets are variables which can be dynamically populated to construct rhetorical topics of varying complexity and application. FIG. 2 illustrates how the rhetorical elements can be populated with rhetorical elements language to form repurposed rhetorical content. The rhetorical elements language consists of rhetorical content associated with the variables of each rhetorical topic. A variety of rhetorical elements language can be dynamically selected so as to repurpose content in a number of ways according to a chosen rhetorical purpose, knowledge of audience, and so on.

Structural elements referred to earlier conform to one or more rules for conveying a coherent expression. For example, written rhetoric as shown in FIGS. 1 and 2 utilizes structural elements governed by common rules of grammar associated with the language in question. Thus when rhetorical elements are combined with structural elements, a coherent expression can be formed such as shown in FIG. 2. It should be noted that although FIGS. 1 and 2 illustrate examples of English rhetoric, it would be apparent to one of ordinary skill in the art that any language is applicable to the present disclosure.

Once a set of rhetorical topics has been formed, a selection of the rhetorical topics such as shown in FIG. 2 can be used to form a communication unit (herein referred to as a “C-Unit”). A C-Unit is formed from a topic statement, one or more comment statements and a point statement. A simple C-Unit can roughly be equivalent to a paragraph. A complex C-Unit can be a combination of simple C-Units to create a larger functional entity within a document.

The topic statement (as is commonly referred to by writers of English) can be formed from a single rhetorical topic (such as the classical definition given in FIG. 2). The topic statement serves to convey to an audience a topic or theme. The comment statement(s) can be formed by one or more rhetorical topics. In the example of FIG. 2, the comment statements comprise the rhetorical topics of a comparison between old and new, a contrast between old and new, a comparison of degree, a capability differentiator, and an option differentiator. Comment statement(s) such as these can provide new information relating to the topic statement such as statements of fact or opinions. The point statement can be similarly formed by a rhetorical topic as shown in FIG. 2. The point statement can serve to convey an objective or purpose to be reached or achieved from a major idea or essential part of a concept or narrative.

A single C-Unit can represent any subset of languages such as a sentence, a paragraph, or a section of paragraphs. A C-Unit can serve to convey a simple message such as commonly found in advertisement clips. A combination of C-Units or complex C-Units, on the other hand, can form a schematic expression which can represent, for example, a complex document consisting of a multiplicity of sections (e.g., a marketing document, a legal agreement, a brochure, a product description, and so on). A C-Unit can be tailored to its audience on the basis of the variable library of rhetorical topics being populated with corresponding rhetorical content.

It should be noted that although FIGS. 1-2 depict written rhetoric, the present disclosure can be applied to audible rhetoric, tactile rhetoric, and other forms of visual rhetoric. Similar in principle to the rules of grammar, rules can be established for audible rhetoric, tactile rhetoric, and visual rhetoric. These rules can serve to combine audible or visual rhetorical elements with corresponding structured elements to convey coherent thoughts and/or messages to any number of audiences.

Audible rhetoric can be represented by, for example, synthesized audible rhetoric or human audible rhetoric. Synthesized audible rhetoric can be generated by common software technologies that synthesize speech to text or text to speech. Human audible rhetoric derives from spoken language by either gender expressed in any context (e.g., formal presentations, drama, musical expressions, oratory, narrative, etc.). Tactile rhetoric can be represented by Braille which can be translated to written rhetoric and vice-versa. Visual rhetoric, of which written rhetoric is a subset, can also represent still image rhetoric (e.g., a cover page, a poster, a picture, a drawing, a sketch, a cartoon, etc.) of animate or inanimate objects, and moving image rhetoric (e.g., 2-D animation, 3-D animation, a video clip, Flash video, etc.). Audible or visual rhetoric can be structured as rhetorical topics constructed from the building blocks of audible or visual rhetorical and structural elements.

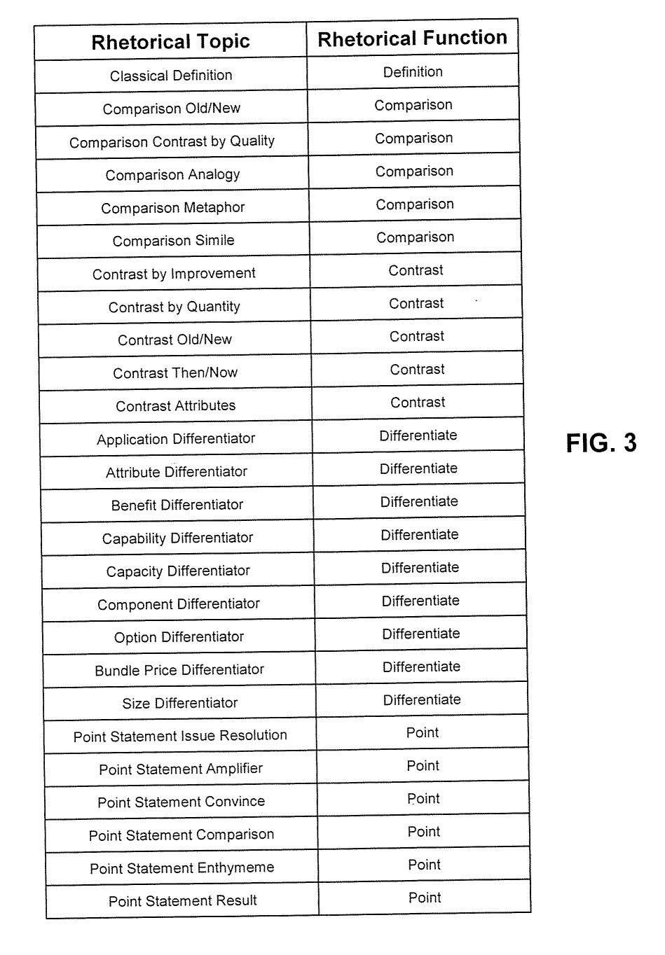

FIGS. 1-2 provide a small sample of C-Unit structures based on rhetorical topics and their building blocks. It would be apparent to an artisan with ordinary skill in the art that innumerable rhetorical topics can be identified from an expansive spectrum of contextual matters. Moreover, rhetorical topics themselves can be refined and subdivided in order to expand the scope of C-Units that can be generated from a rhetorical topic variable library. With this flexibility, C-Units can be tailored to a type of audience (e.g., novice, experienced, expert, young, middle aged, old, male, female, etc.). The table in FIG. 3 illustrates how the rhetorical topics of FIGS. 1 and 2 can be further refined. As should be evident from this table, rhetorical topics can be refined as much as may be deemed necessary. Although not shown, for each rhetorical topic of FIG. 3 a framework of variable rhetorical and structural elements can be formed similar to what is shown in FIG. 1. For convenience, the rhetorical topic variable library (a sample of which is shown in FIG. 1) will be referred to herein as a rhetorical topic library.

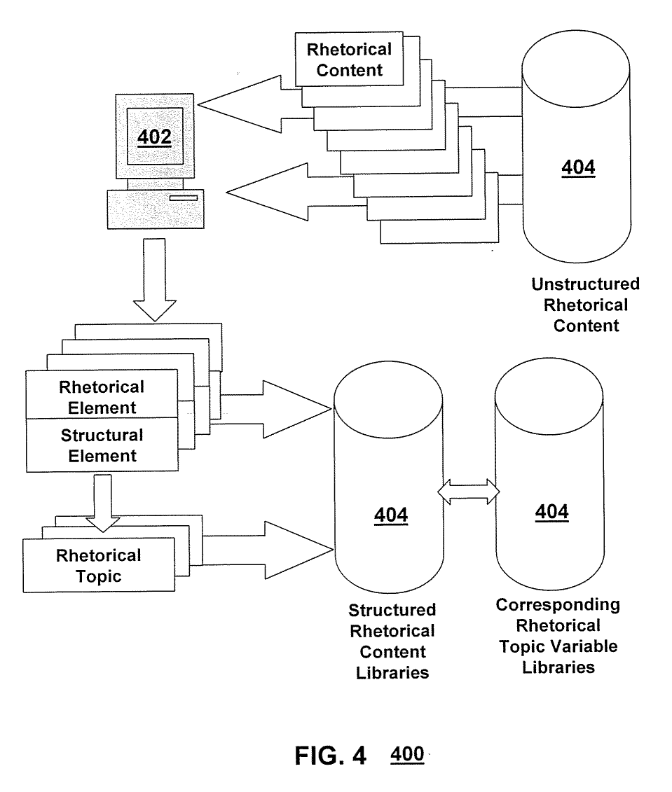

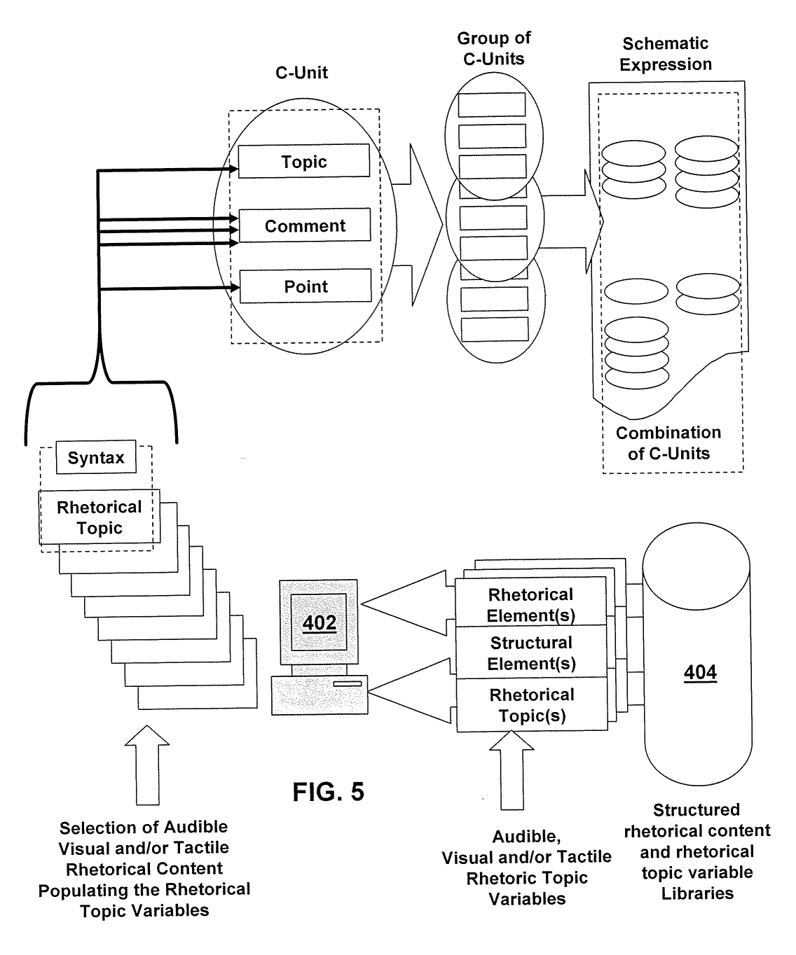

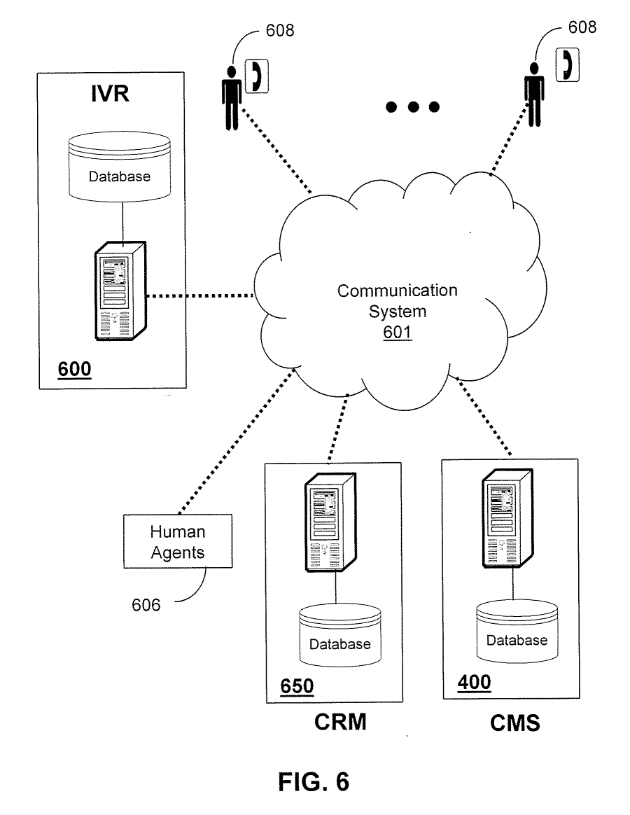

FIGS. 4-5 depict exemplary embodiments of a content management system (CMS) 400 for analyzing, deconstructing, reconstructing, and repurposing rhetorical content. The CMS 400 comprises a controller 402 and a database 404 several instances of which are shown in FIG. 4. The controller 402 can comprise a computing device such as a server for managing operations of the database 404 as disclosed herein. The database 404 can comprise mass storage media such as one or more high capacity disk drives for storing any of the rhetorical content types (e.g., audible, visual or tactile rhetoric) described above. FIG. 6 depicts an exemplary embodiment of the CMS 400 operating in a communication system 603.

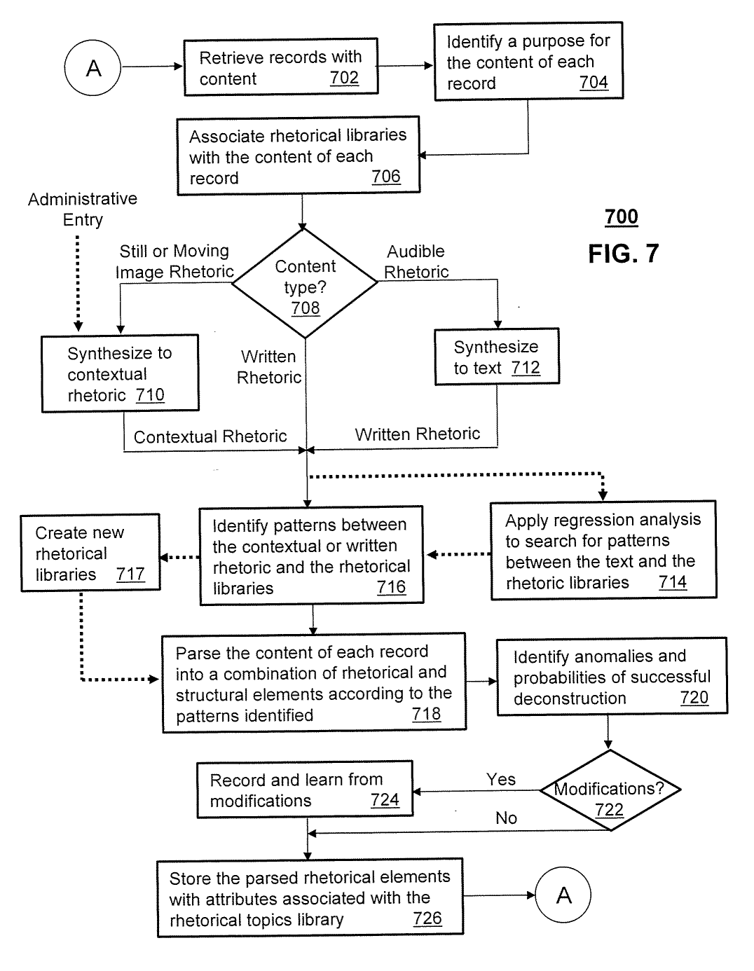

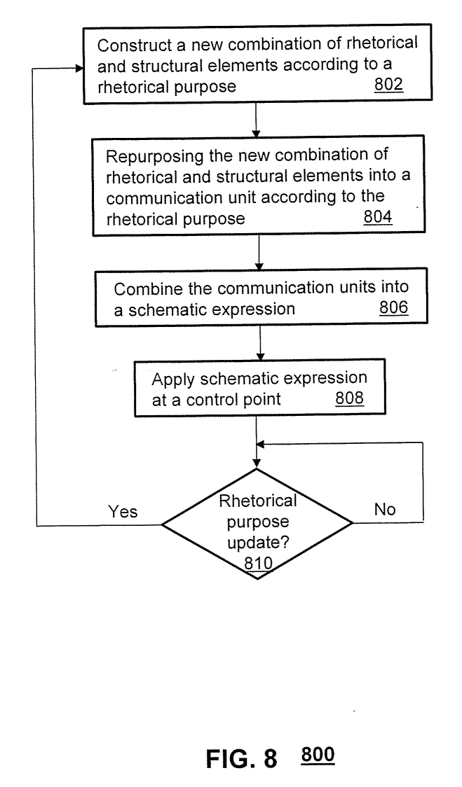

To facilitate an understanding of the embodiments of FIGS. 4-6, the reader's attention is directed to FIGS. 7-8 which depict exemplary methods 700-800 operating in the CMS 400. FIG. 7 depicts an exemplary method 700 for analyzing, deconstructing, and reconstructing rhetorical content. FIG. 8 depicts an exemplary method 800 for repurposing reconstructed rhetorical content. Method 700 can be utilized for analyzing, deconstructing, and reconstructing any of the rhetorical content types discussed earlier into structured rhetorical content associated with rhetorical topic libraries. Method 700 can be useful for reengineering legacy rhetorical content. Once the reconstruction process is completed, method 800 can be applied for dynamically repurposing the reconstructed content.

Method 700 begins with step 702 in which the controller 402 of the CMS 400 retrieves records from its database 404. This step represents the retrieval of unstructured rhetorical content that needs to be analyzed, deconstructed, and reconstructed into structured rhetorical content associated with the rhetorical topic library as shown diagrammatically in FIG. 4. Each record of rhetorical content retrieved in step 702 is “unstructured” in the sense that no one has defined the functions that each portion (e.g., sentences) of the retrieved rhetorical content is desired to fulfill. In step 704, the controller 402 is programmed to identify a purpose for the rhetorical content retrieved for each record. The controller 402 can be programmed with conventional software to recognize contextual information from the unstructured rhetorical content of each record, or the contextual information can be provided by personnel of the CMS 100. The contextual purpose identified can be of any kind. For instance, the rhetorical content can consist of marketing materials, advertisement, legal agreements, research documents, product descriptions, technical support methods, call processing trees for an IVR, and so on. Thus, rhetorical content can have any identifiable purpose.

In one embodiment, the method can include receiving a user input entered in a plurality of grammatical structured text entry elements associated with a content subject; storing the plurality of grammatical structured text entry elements in a data record associated with the content subject; converting at least a portion of the data record into a structured format file supporting rhetorical elements; and rendering an electronically displayable document using the structured format file. Each of the plurality of grammatical structured text entry elements can have a rhetorical structure to facilitate selective assembly into at least one sentence. The structured format file can include at least one grammatical structured text entry element of the plurality of grammatical structured text entry elements. The electronically displayable document can include the at least one grammatical structured text entry element integrated into at least one sentence. In another embodiment, a content management input tool can be utilized that includes an entry page associated with a content subject. The entry page can include a text entry form element for receiving input text having a specified length. The input text can be constrained in accordance with a grammatical syntax format associated with a rhetorical rule and structure, and a selection element can be configured to initiate manipulation of a data record associated with the content subject upon activation of the selection element. The data record can be stored in a database. In another embodiment, a content delivery application can be utilized that includes a gateway program configured to receive requests associated with a content subject where the requests are received via a distributed network. A rhetorical data file can be utilized that includes a tag-separated data structure. The tag-separated data structure can identify a set of grammatical phrase structures.

In one embodiment, a parser can be utilized that is responsive to the rhetorical data file. The parser can be configured to selectively construct content relating to the content subject using at least one grammatical phrase structure of the set of grammatical phrase structures. The parser can be configured to provide the content to the gateway program. In yet a further embodiment, a rhetorical content model can be utilized that includes a first computer retrievable grammatical syntax element associated with a rhetorical structure and a second computer retrievable grammatical syntax element associated with the rhetorical structure. The rhetorical structure can facilitate selective assembly of the first computer retrievable grammatical syntax element and the second computer retrievable grammatical syntax element into a sentence.

In step 706, the controller 402 can be programmed to associate rhetorical topic libraries existing in its database 404 with the rhetorical content of each record according to the rhetorical content's purpose. The rhetorical topic libraries represent pre-existing rhetorical topic variable structures stored in the database 404 (such as shown in FIG. 1). The greater the number of rhetorical topic library structures, the more likely the controller 402 can identify one or more patterns in the unstructured rhetorical content retrieved in step 702.

In step 708, the controller 402 can be further programmed to segregate the rhetorical content by content type. For still or moving image rhetoric, the controller 402 proceeds to step 710. For written rhetoric, the controller 402 proceeds to step 716, while for audible rhetoric the controller 402 proceeds to step 712. In step 710, the controller 402 can be programmed to synthesize still or moving image rhetoric into contextual rhetoric by way of conventional image recognition techniques. Contextual rhetoric can represent textual descriptions of a theme or motif corresponding to the still or moving rhetoric. Alternatively, the contextual rhetoric can be supplied by an administrator who has analyzed the visual rhetoric. In yet another embodiment, textual descriptions can accompany the still or moving images to facilitate deconstruction, reconstruction, and repurposing of said images. In step 712, the controller 402 can be programmed to synthesize audible rhetoric into written rhetoric using common speech to text synthesizes software.

Once the audible or visual rhetoric has been processed, the controller 402 proceeds to step 716 where it identifies patterns between the contextual or written rhetoric and the rhetorical topic libraries selected in step 706 on a per record basis. Pattern recognition can be performed by common statistical techniques such as regression analysis. The controller 402 can, for example, process the rhetorical content in step 714 by regression which can involve fitting a model to the rhetorical content with both deterministic (predictor) and stochastic (error term) components.

If the comparison between the content and the rhetorical libraries results in a match or nearly a match, the controller 402 can proceed to step 718 where it parses and stores the rhetorical content into a combination of audible and visual rhetorical elements according to the patterns identified in steps 714-716. The stored parsed content can have functional attributes (e.g., pointers) that associate said content to one or more corresponding matching variables in the rhetorical topic libraries as identified by the foregoing patterns. If, on the other hand, the comparison between the rhetorical libraries and the content is substantially dissimilar, the controller 402 can be programmed to proceed to step 717 where it can create one or more new variable rhetorical element entries in the rhetorical library. From step 717, the controller 402 proceeds to step 718 to parse and store the rhetorical elements according to these new library entries. The rhetorical elements similarly include functional attributes of association with the new library entries.

In step 720 the controller 402 can be further programmed to identify anomalies and/or probabilities of successful deconstruction on a per record basis. An anomaly can be identified by common pattern recognition and comparison techniques. For example, an anomaly can be detected according to poor correlation, poor variance, or a wide standard deviation generated in step 714 for one or more records. Similarly, the regression technique of step 714 can generate a probability (or confidence) of success or error in the patterns detected for each record.

In step 722, the controller 402 can be programmed to accept modifications from personnel (or draftspersons) managing the CMS 100. Personnel can make modifications to parsed rhetorical elements having an anomalous or low probability tag generated in step 720. Personnel can also analyze and make modifications to any other portion of the parsed rhetorical elements according to errors missed by the CMS 100. If such modifications are made, the controller 402 records the modifications and can be programmed to learn from the modifications using the same or similar statistical techniques referred to in steps 714-716. If no modifications are made, the controller 402 proceeds to step 726 where it stores the parsed combination of audible and visual rhetorical elements in the database 404. Based on the lessons learned from deconstructing the rhetorical content retrieved in step 702, and the modifications made in step 722, the controller 402 can be programmed to improve steps 702-726 for future iterations.

Once audible and visual rhetoric has been reconstructed into structured rhetorical content by the steps of method 700, it can be repurposed according to method 800 as described in FIG. 8. Method 800 can begin with step 802 where the controller 402 constructs according to a rhetorical purpose a new combination of one or more rhetorical and structural elements from the second plurality of records associated with the rhetorical topic library by the functional attributes. The rhetorical purpose can be supplied by an administrator who is requesting the product. For example, the rhetorical purpose might be a software licensing agreement. Based on an expansive library of rhetorical topics relating to this rhetorical purpose the controller 402 can be directed in step 804 to repurpose the combination of rhetorical topics into a number of C-Units. For example, one C-Unit can represent the agreement preamble, another can represent a definition section, another can represent grant clauses, another can represent confidentiality clauses, and so on. In step 806, the controller 402 can combine the C-Units into a schematic expression which in this illustration represents the license agreement in question. FIG. 5 illustrates the aforementioned repurposing process diagrammatically.

In a supplemental embodiment, the controller 402 can be programmed to dynamically apply in step 808 the schematic expression at a control point such as, for example, the IVR 600 shown in FIG. 6. The schematic expression in this embodiment can be a call processing tree represented by a number of C-Units including written rhetorical topics (to be later synthesized into speech by the IVR 600) or pre-synthesized into audible rhetorical topics each of which are invoked by a caller 608 as s/he navigates through the menu of the IVR 600.

In step 810, the controller 402 can be further programmed to detect a need to repurpose one or more C-Units of the call tree. The detection mechanism of step 810 can be driven in part by feedback from the IVR 600 such as a statistical use of the call processing tree. Such statistics can identify, for example, excessive call tree navigations by callers 608 (indicating perhaps confusion and lack of efficiency in the call tree), excessive call terminations by the callers 608 without accomplishing a desirable task (e.g., purchasing a product), and/or direct caller feedback by way of surveys.

With such information, the CMS 100 can dynamically repurpose the call processing tree with iterative changes to the C-Units and/or the rhetorical and structural elements constructed in step 802 to achieve better navigation efficiencies and customer satisfaction. Alternatively, or in combination, the call tree can be dynamically repurposed by the CMS 100 according to business rules such as sell through, and demographics and/or psychographics determined from a CRM (Customer Relationship Management) system 650 for each caller. These rules can be used to repurpose C-Units which can include offers with individualized promotions, rebates, or coupons.

The IVR 600 can also serve as a technical support center in which the CMS 100 can dynamically repurpose a technical support call processing tree according to the caller's level of expertise and needs. Similarly, dynamically repurposed C-Units can be utilized by human agents 606 operating at sales, billing, technical support, or trouble shooting call centers. The CMS 100 in these instances can dynamically repurpose reconstructed rhetorical content on the basis of the agents needs or observed behavior of the agents' access to informational databases.

The reconstructed rhetorical content can also be used in websites operating in the communication system 601 which can support a hybrid of wireline (e.g., Plain Old Telephone Service or POTS), and wireless services (e.g., cellular, WiFi, WiMax, Software Defined Radio-SDR, and so on). The websites can be dynamically repurposed by the CMS 400 for frequently asked questions (FAQs), advertisements, product descriptions, pricing, and so forth. If the caller 608 is a known customer, the CMS 100 can also be programmed to repurpose reconstructed rhetorical content on the basis of known information of the customer (e.g., currently used services, complementary services that can be offered, pricing discounts for customers with a high credit rating, etc.).

In one embodiment, an input tool can be used to gather content segments and store those segments in a database. The content segments may, for example, be sentence fragments, phrases, nouns, sentences, and paragraphs. In one exemplary embodiment, sentence fragments are entered, following a specific grammatical format that fulfills a specified rhetorical purpose. Using the rhetorical format, parts of a sentence may be gathered, stored and associated as fields in the content database. Rhetorical principles control the development of the syntax from the grammatical elements and drive the deployment of the content to the application based on the communication function that the write wants to achieve. The applications may construct content using the various formats or models. Some of the fields in the record may, for example, follow a rhetorical model. In this example, the model utilizes sentence elements having a specific grammatical form designed to meet a particular rhetorical or communication function. The sentence elements or grammatical syntax rules may be used to construct a sentence.

In one exemplary embodiment, the rhetorical model may be used to form a sentence having three elements, a product name, product class, and product description as shown below. The rhetorical/communication function that this grammatical construct is designed to achieve is DEFINE: <<Product name>> is a <<product class>> that <<product description>>. To produce a grammatically correct sentence, the elements can follow specific grammatical forms. For example, the product name is a noun, the product class may be a noun that agrees with the singular verb “is” and singular article “a”, and the product description may be a phrase beginning with a third-person singular active verb. An example is <<A chair>> is a <<piece of furniture>> that <<has four legs, a platform for sitting, and a back to lean against>>.

In one embodiment, the input tool can be utilized to receive content segments or rhetorical units and store those segments in a database. The content segments are not necessarily limited in form or substance and may, for example, be words, sentence fragments, phrases, nouns, partial sentences, complete sentences, graphics, legal disclaimers, and/or complete paragraphs. In one exemplary embodiment, sentence fragments having rhetorical content may be entered. These sentence fragments may have a specific grammatical format and fulfill a specified rhetorical purpose.

It should be noted that one or more of the exemplary embodiments described herein can differ from a system that creates content on a ready-made basis. The present disclosure can provide a means for deconstructing, constructing and repurposing content on demand. The exemplary embodiments can be flexible and adaptable to commercial needs as they may arise. It should also be evident from the foregoing descriptions that there is simply no limit to the applications for analyzing, deconstructing, reconstructing, and repurposing rhetorical content as described by the claims set out below. For example, a proposal builder or e-brochure builder can be provided, where a content server may provide the content elements as a data record set. Applications can interpret the data record set, selectively utilizing the content elements to develop context-specific content. The content may then be provided in a document, flash file, PDF, or other electronic format. In one embodiment, a website may be delivered to users. The pages may include content automatically created using the content elements stored in the database. An application server can receive requests associated with a content subject from browsers. The application server may have a gateway program that acts to receive the requests and provide the output. In exemplary embodiments, the gateway server can receive HTTP requests and provide each HTML web page content. For instance, upon receiving a request from the gateway program, the application server may acquire an extensible markup language (XML) file associated with the requested content subject. The XML may have tags that identify the elements. The XML file may be interpreted by an XML parser. The XML file may be associated with a document type definition (DTD) file and further interpreted in accordance with the document type definition (DTD) file. The application server may also include an XSL file as interpreted by an XSL processor. Together, the XML parser and the XSL processor provide content elements to the gateway program. The gateway program assembles the content elements into content included in the web pages. Each web page may utilize different elements derived from the grammatical syntax fields stored in the database and transferred utilizing the XML file. In this manner, the content elements may be utilized in accordance with the intended purpose of the content.

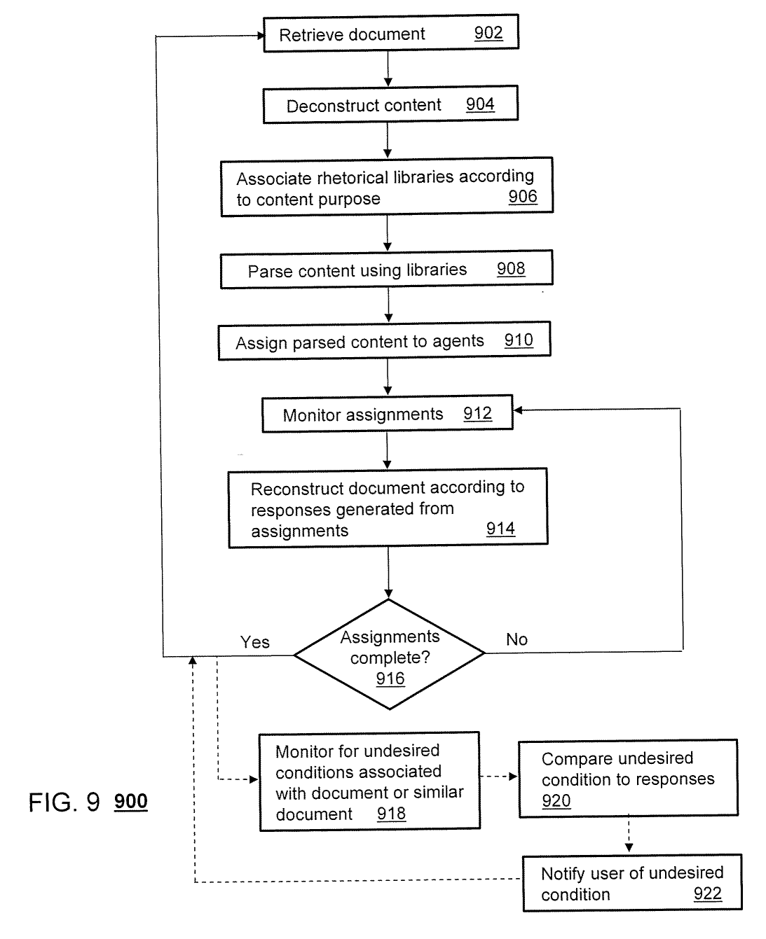

FIG. 9 depicts an illustrative method 900 that operates in portions of the communication system embodied in one or more of FIGS. 1-8. Method 900 can begin with step 902 where the Content Management System (CMS) 400 retrieves or otherwise accesses a document, such as a Request For Proposal (RFP). The RFP can be related to various subject matter such as for the commercial providing of services, products and so forth. In step 904, the content of the RFP can be deconstructed, such as through use of the CMS 400. Content purpose can be determined for each of the deconstructed content by the CMS 400, and rhetorical libraries can be associated with the content based upon its determined purpose in step 906. In step 908, the content can be parsed by the CMS 400 using the associated rhetorical libraries.

In step 912, project management procedures can be applied to the retrieved and processed document. For instance, the project management procedures can be implemented through assignments to various team members for responding to the RFP, which can be monitored and/or maintained by the CMS 400. For example, the CMS 400 can be used by a proposal manager to identify the team members and to assign portions of the RFP to certain team members. In one embodiment, the CMS 400 can present information regarding potential team members and their capabilities for responding to the RFP, such as past RFP assignments, work experience and so forth. In another embodiment, the CMS 400 can designate team members based upon historical information, such as pervious team membership, previous RFP assignments, quality ratings related to previous team membership and so forth. In one embodiment, the designation by the CMS 400 can then be approved or adjusted by a user, such as the proposal manager, the individual team member and so forth. The CMS 400 can monitor the assignments by tracking answers provided by the team members. The monitoring can include notifying team members of upcoming due dates, answers being generated by other team members and so forth.

In step 914, the CMS 400 can reconstruct the document to create a proposal according to the answers generated from the assignments. In one embodiment, the format of the reconstructed document can be based on the evaluation of the RFP by the CMS 400. For instance, the CMS 400 can perform the steps of deconstruction, content purpose determination, library association, and parsing, and based on these steps the CMS can determine the particular structure of the proposal that is to be generated. For example, an RFP may require that answers be inserted directly into the RFP that was originally posted. As another example, page limits, font and other limitations can be imposed by the RFP, as well as designation of the subject matter that is to be included in particular portions of the response. The CMS 400 can determine the designations and other limitations, and structure the proposal accordingly. In one embodiment, the CMS 400 can receive answers from the assignments and then reformat the answers according to the requirements of the RFP. This can allow the team members to provide answers in a format that is more suitable to them while providing a proposal that satisfies the RFP requirements.

In step 916, the CMS 400 can determine if all of the assignments have been completed. If the assignments have not been completed, the method 900 can return to step 912 to continue monitoring. If the assignments have been completed then method 900 can return to step 902 for retrieving the next document. In one exemplary embodiment in step 918, the CMS 400 can monitor for undesired conditions associated with the response to the RFP. The CMS 400 can compare known undesired conditions to the generated proposal in step 920 and notify the team member of the undesired condition in step 922. For instance, the CMS 400 can maintain historical information associated with past proposals and their success rates. The CMS 400 can compare the current RFP questions and/or answers to the historical information to predict success or otherwise determine undesired conditions. The undesired conditions can be based on various conditions such as answers of previous proposals that were deemed unsuitable.

In one embodiment, the CMS 400 can retrieve previous proposals of third parties that were successful and compare those third party proposals to the previous proposal of the user in order to determine undesired conditions, such as cost structure, scope of experience, format of proposal and so forth. These comparisons can be stored as historical information so that a current proposal can be evaluated based on successful previous proposals and unsuccessful previous proposals.

In one embodiment, the CMS 400 can search for similar RFP elements with previously used responses to increase reuse and efficiency. The CMS 400 search tool can provide enterprises a means for reuse and/or policy enforcement for particular RFP response(s). The CMS 400 can track who is responsible for which elements of the RFP, define milestones, responsibilities, and track the performance of a team working on the RFP, including individual performance evaluation.

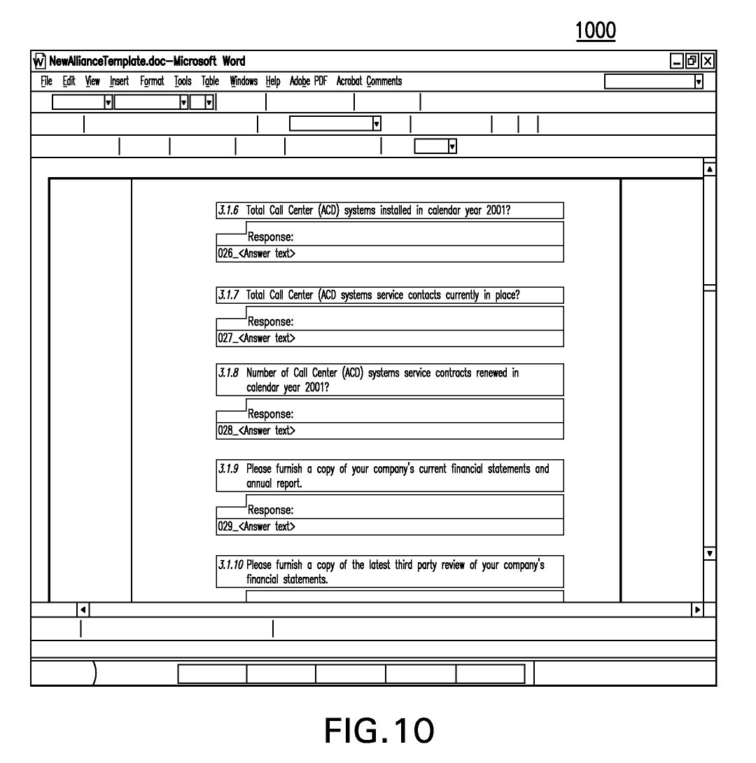

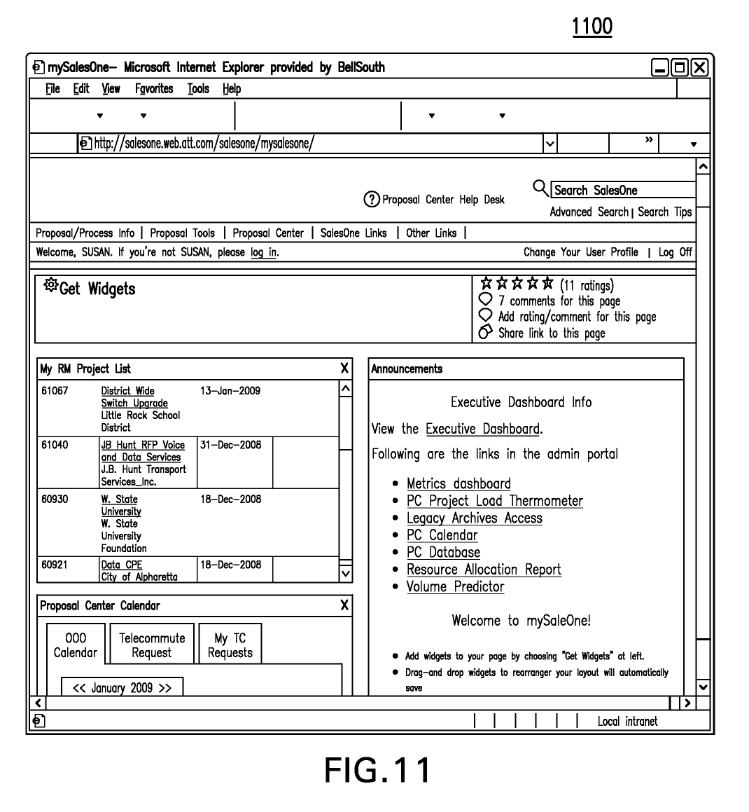

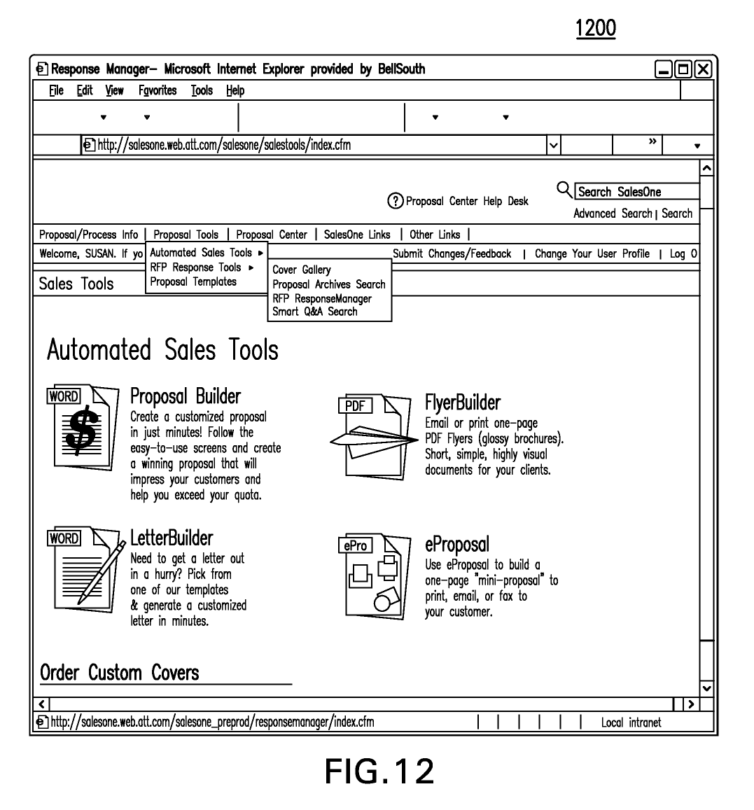

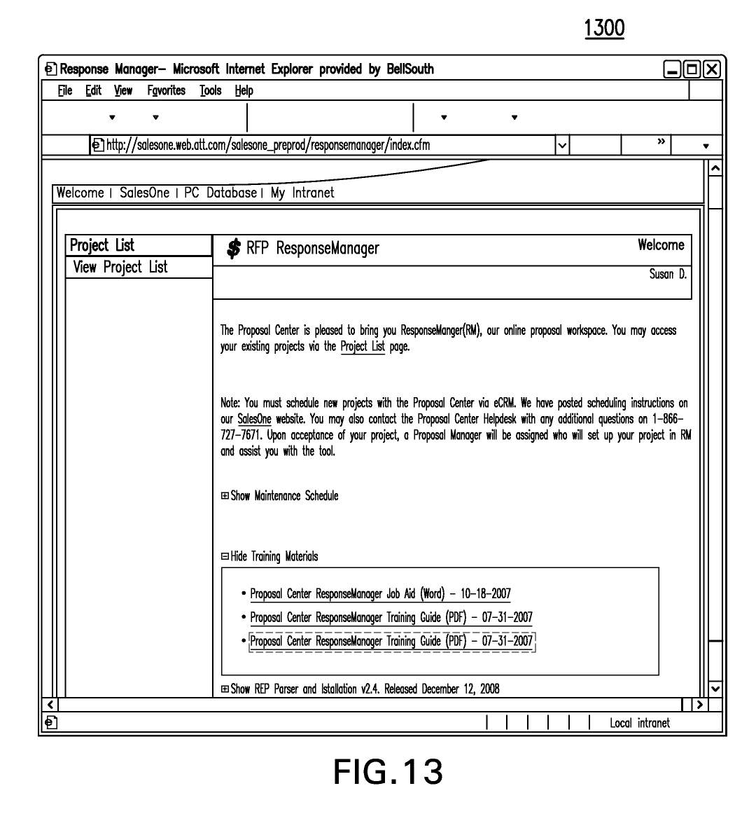

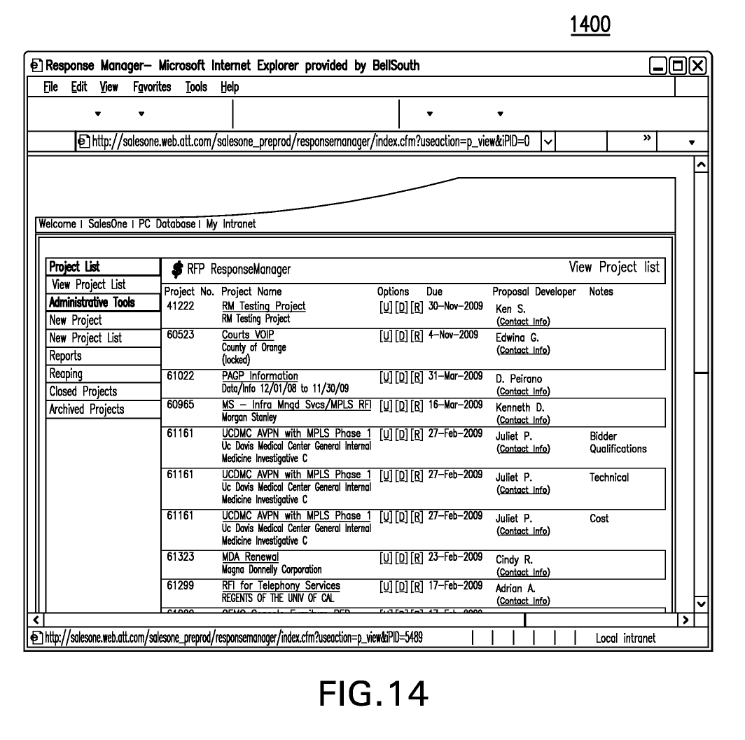

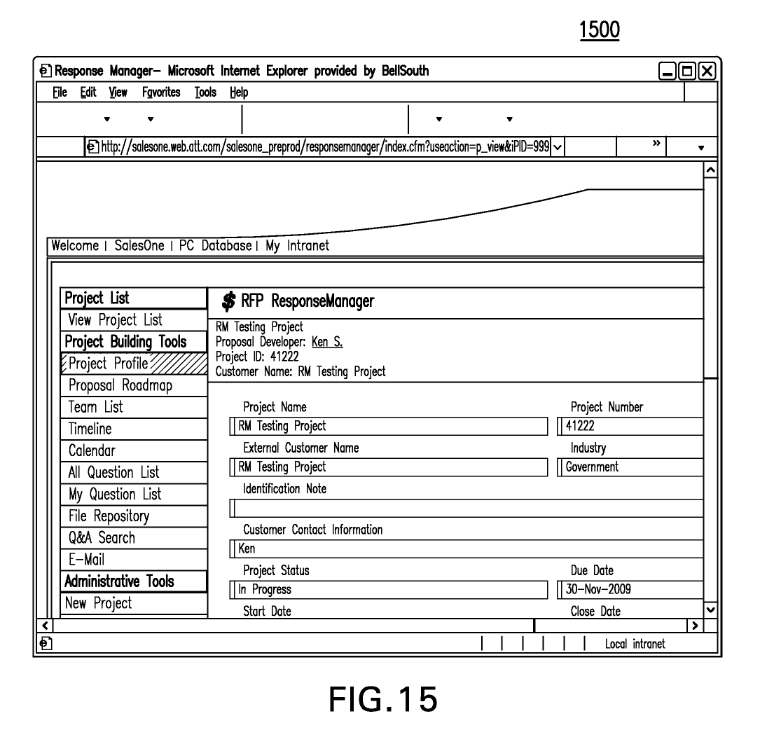

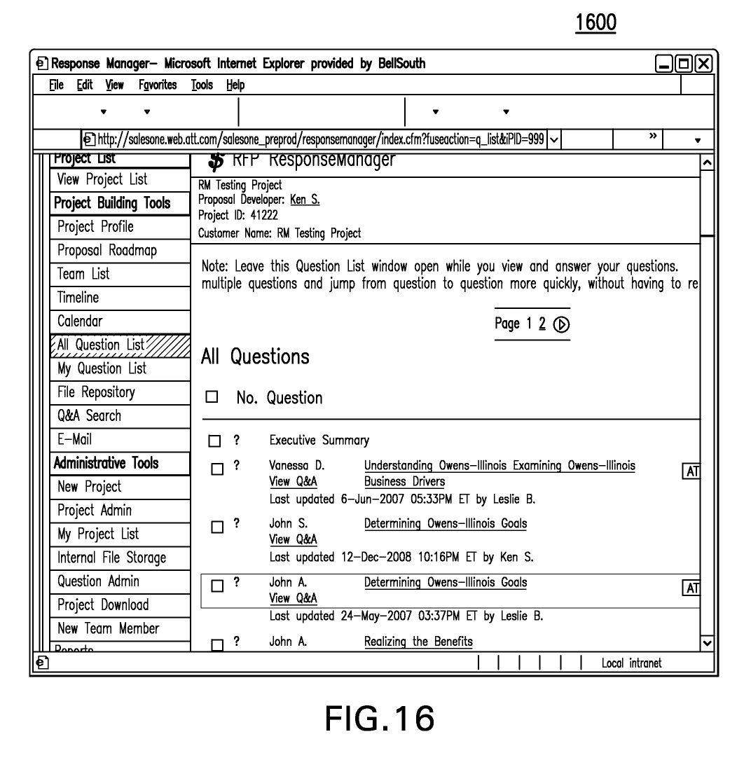

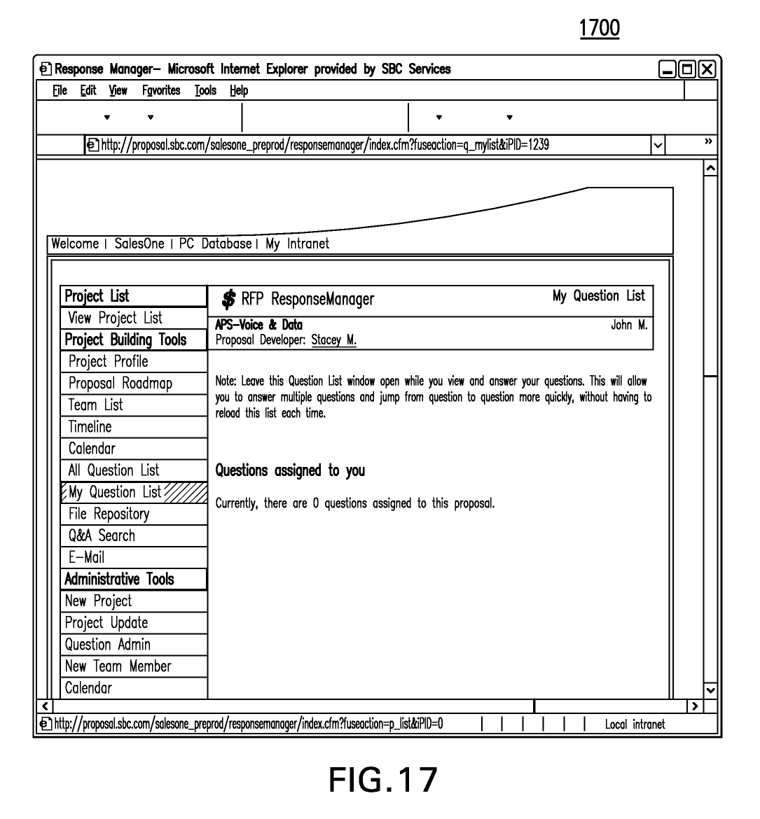

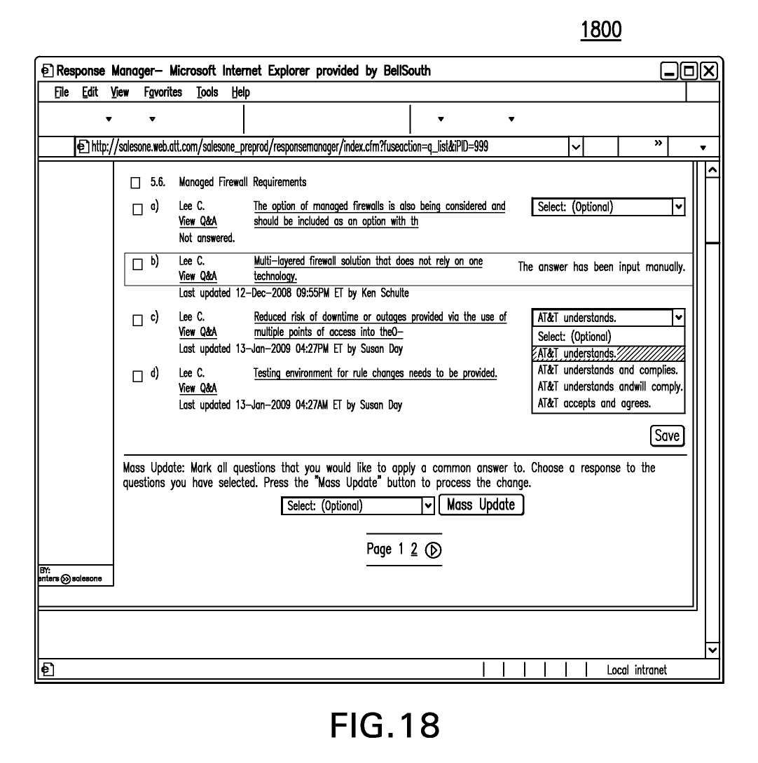

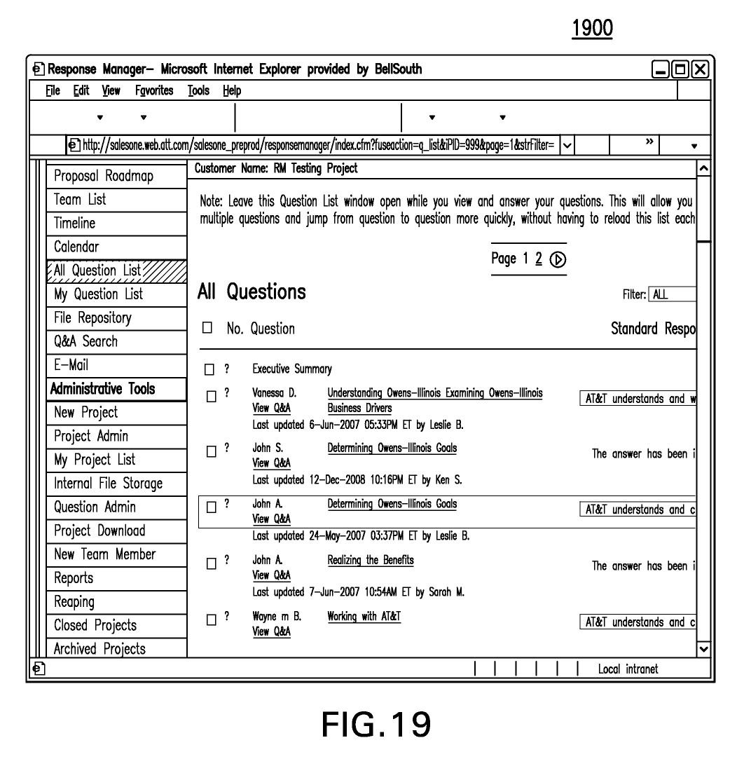

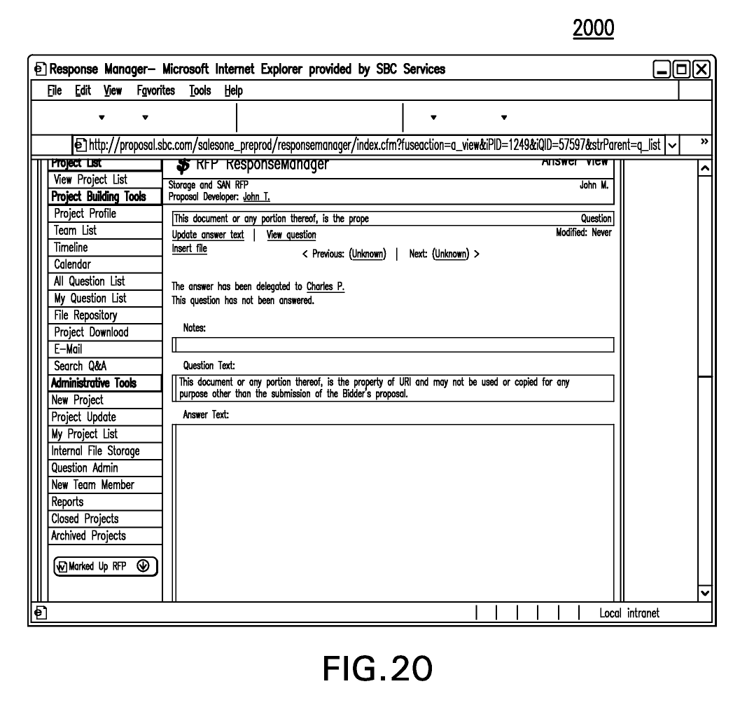

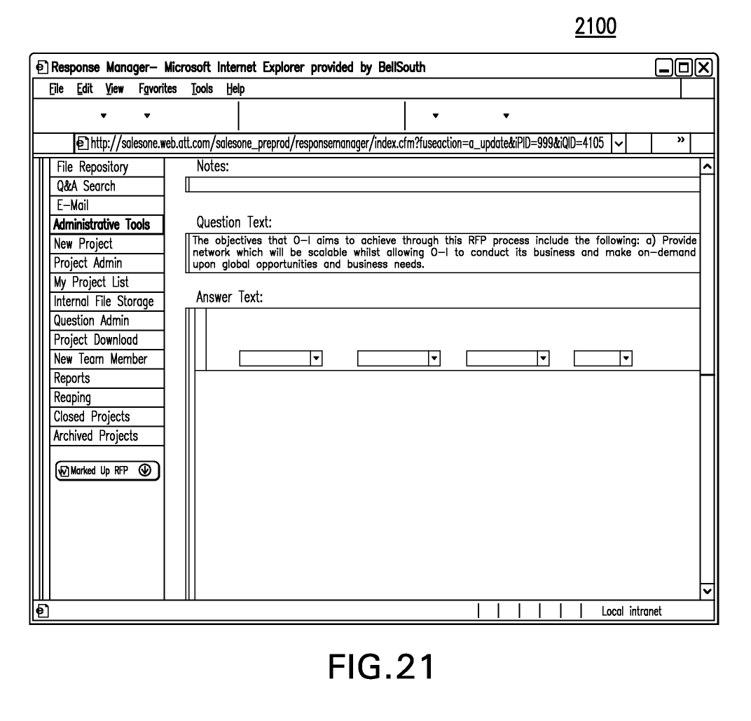

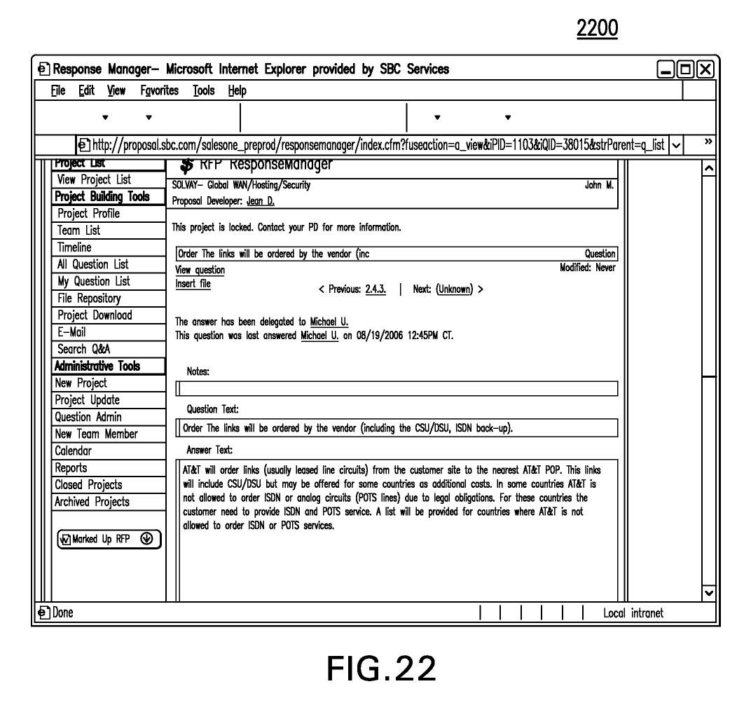

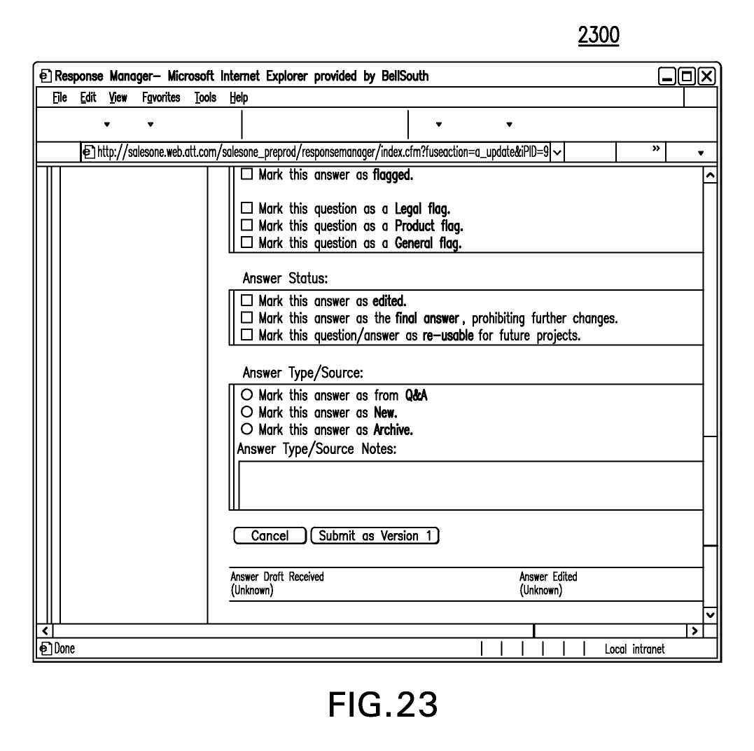

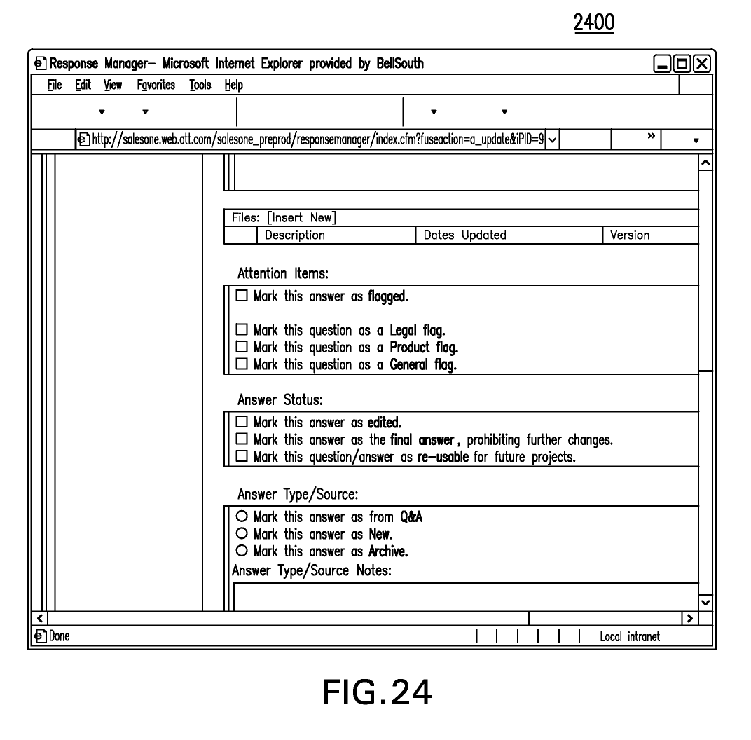

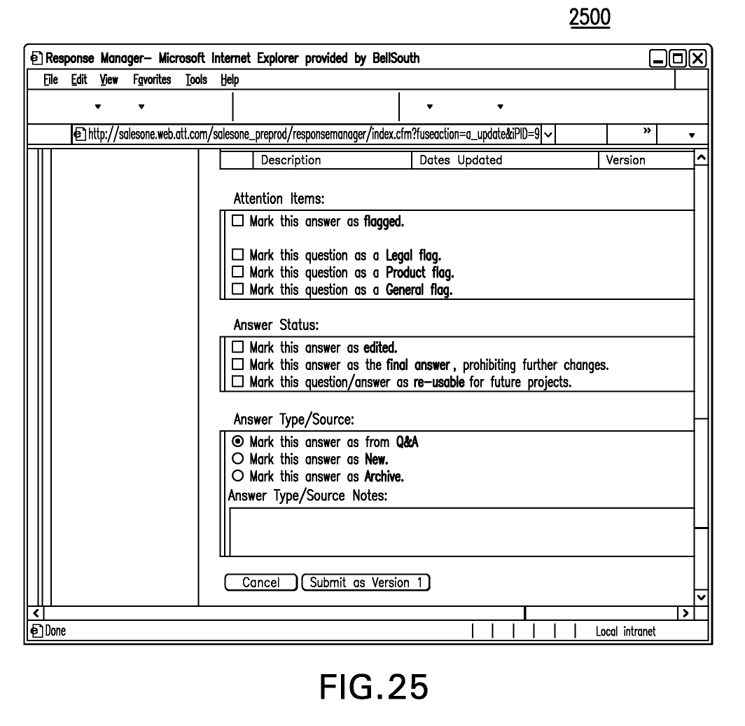

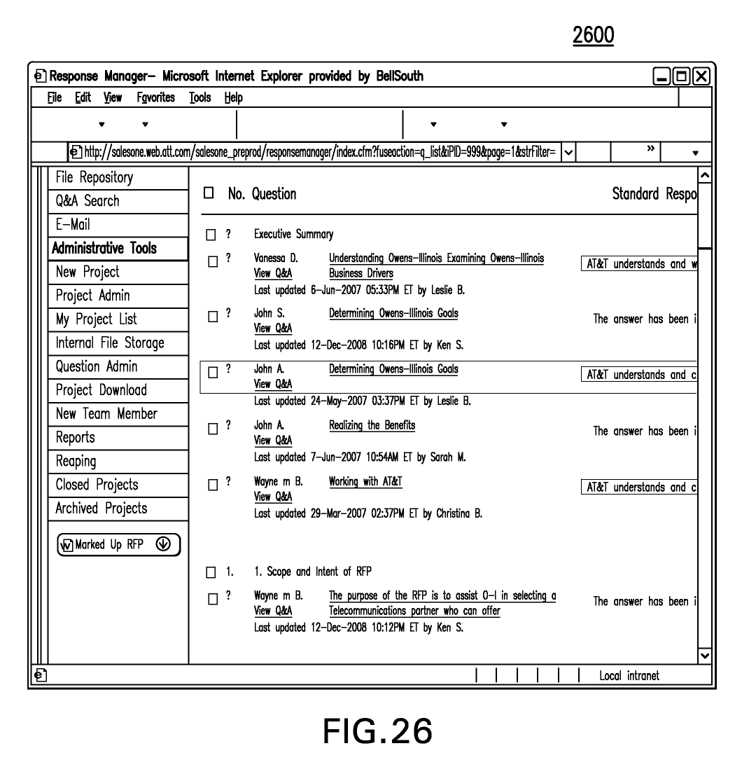

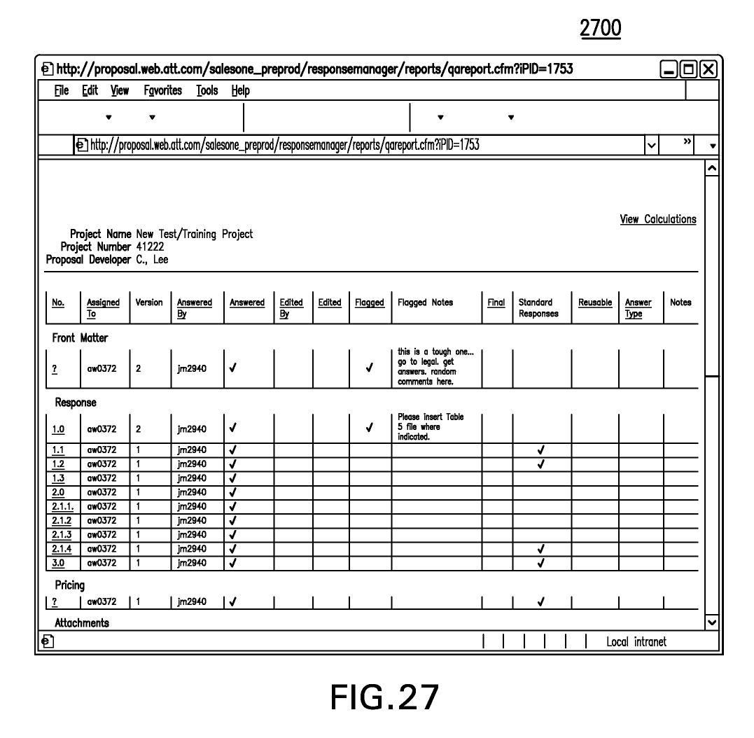

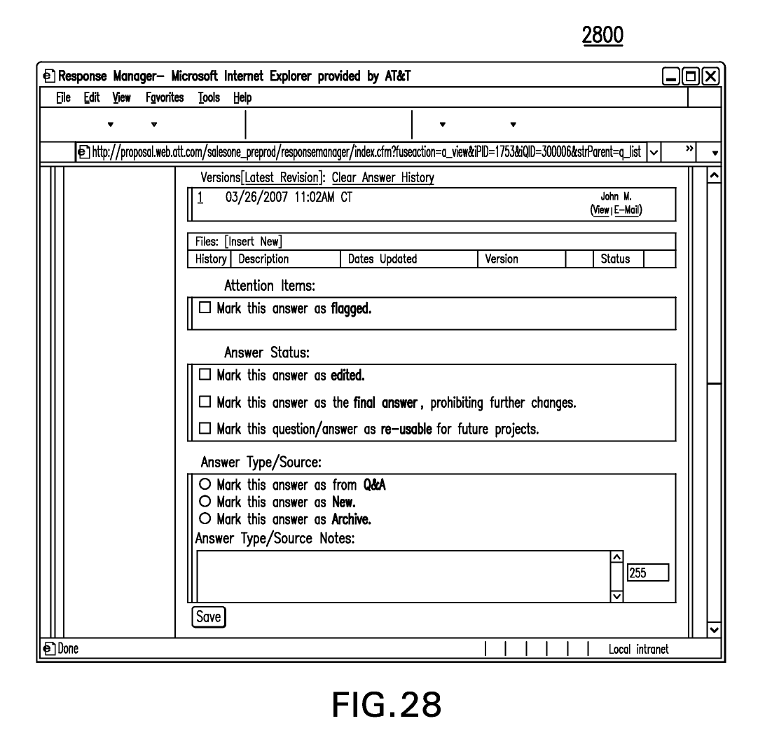

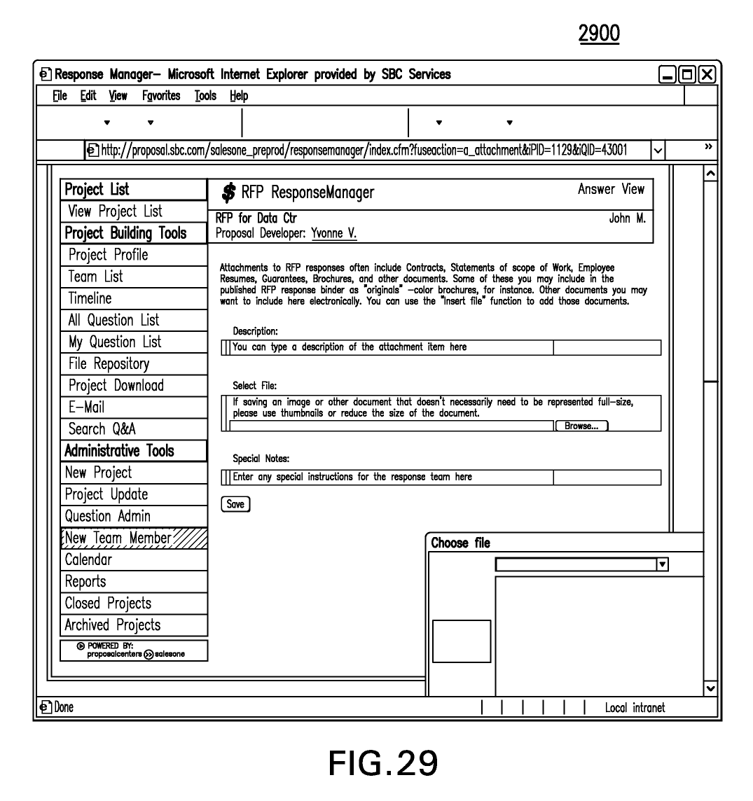

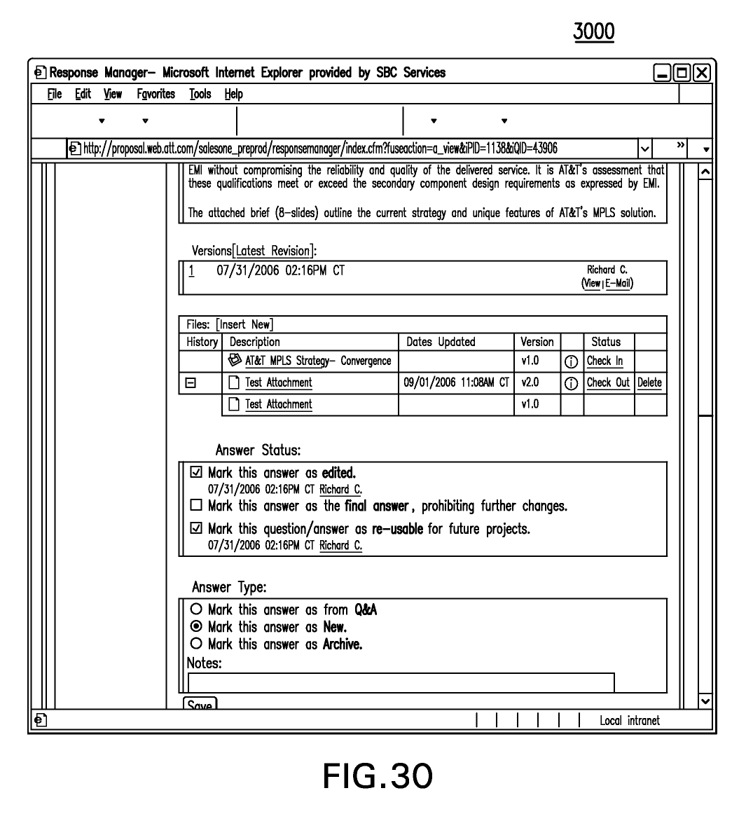

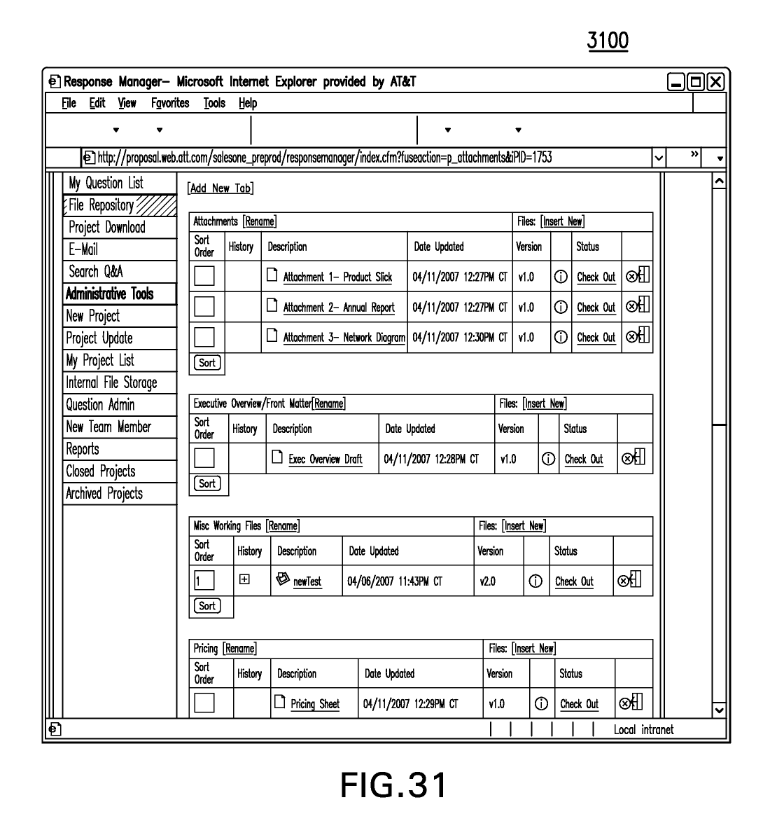

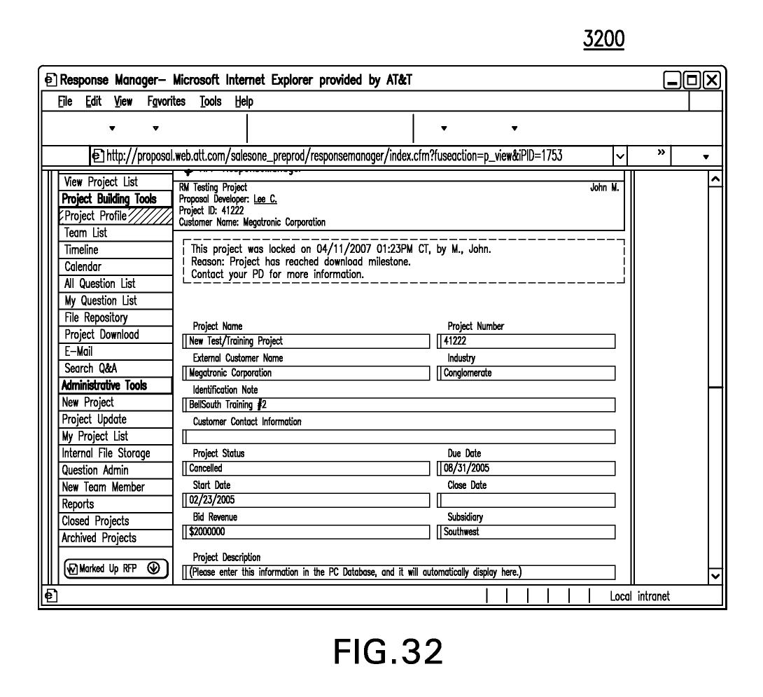

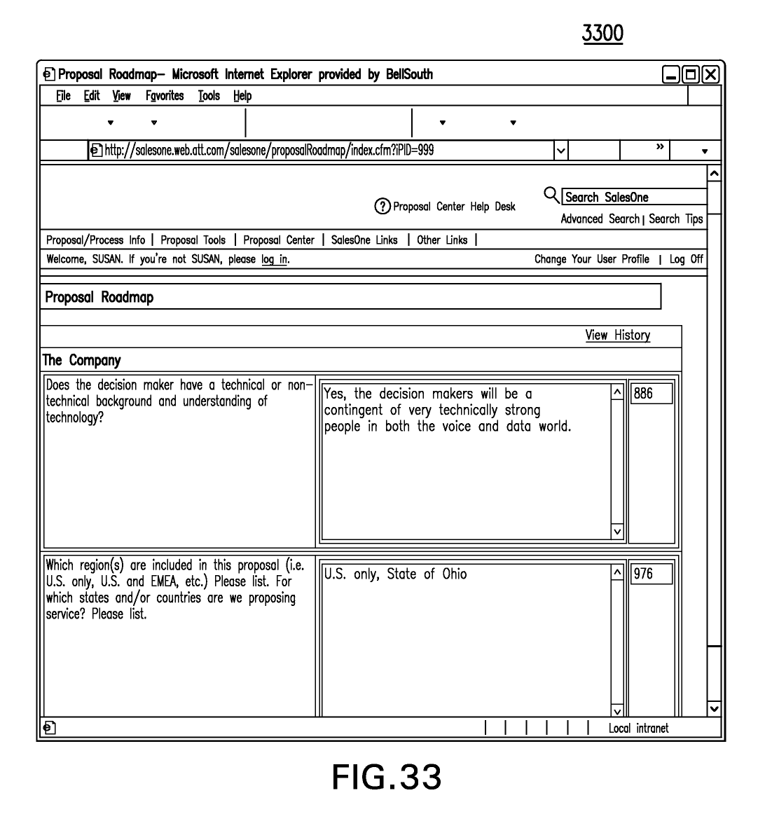

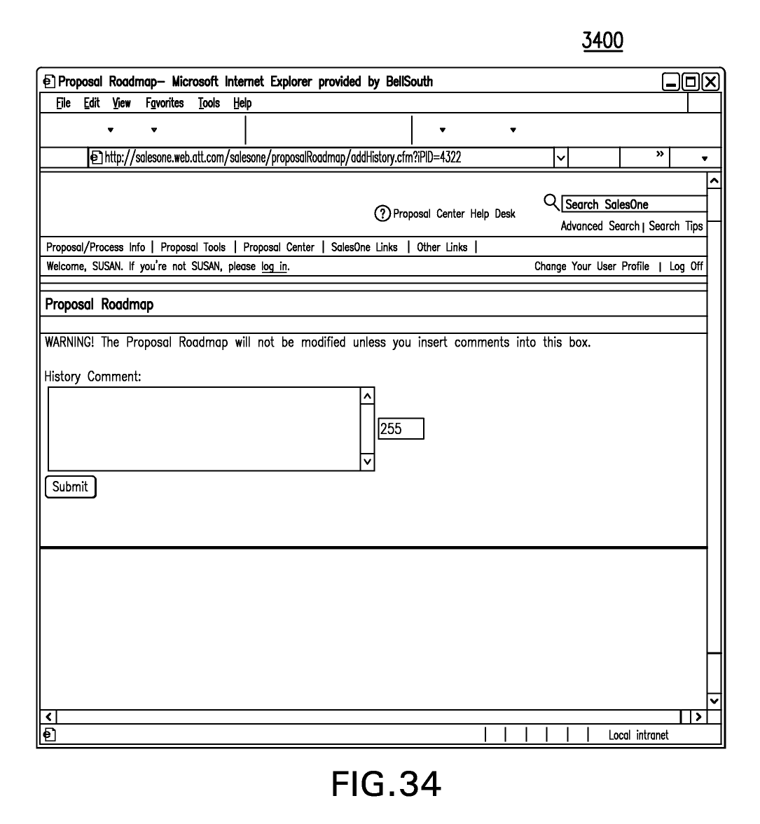

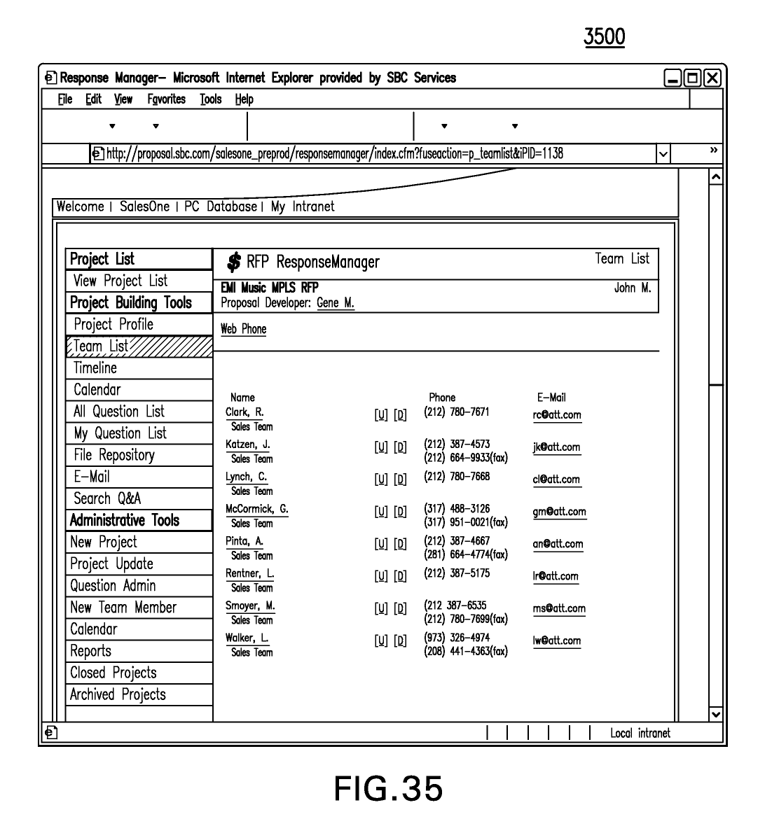

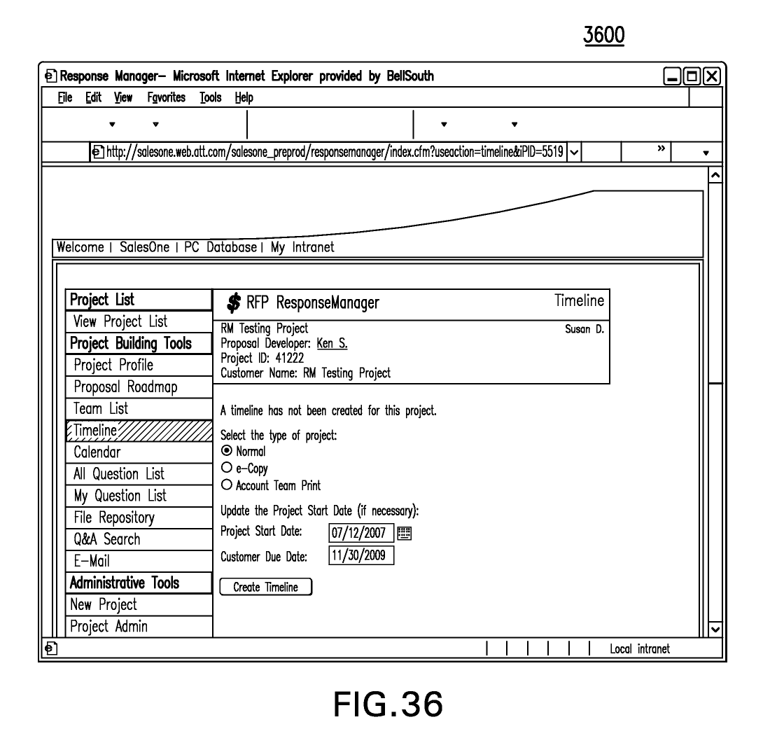

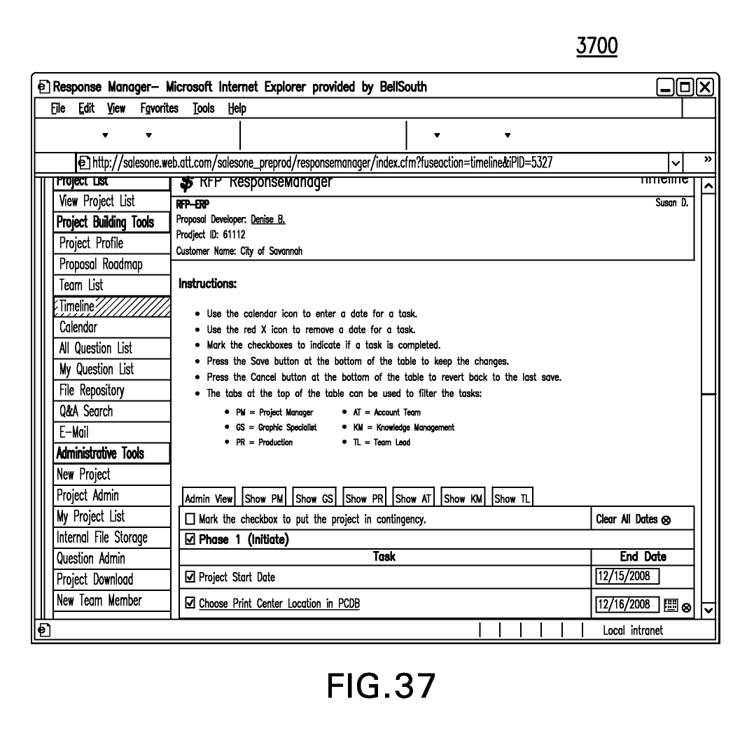

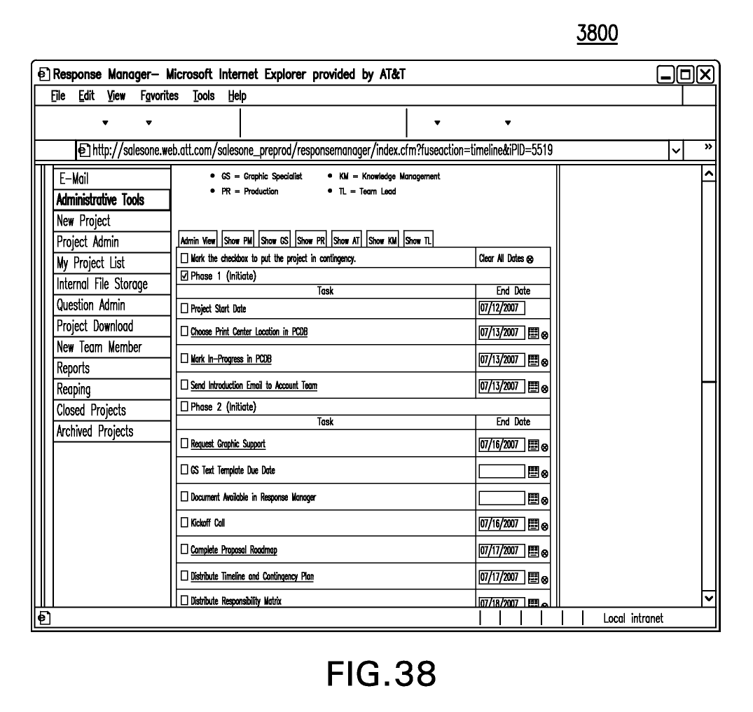

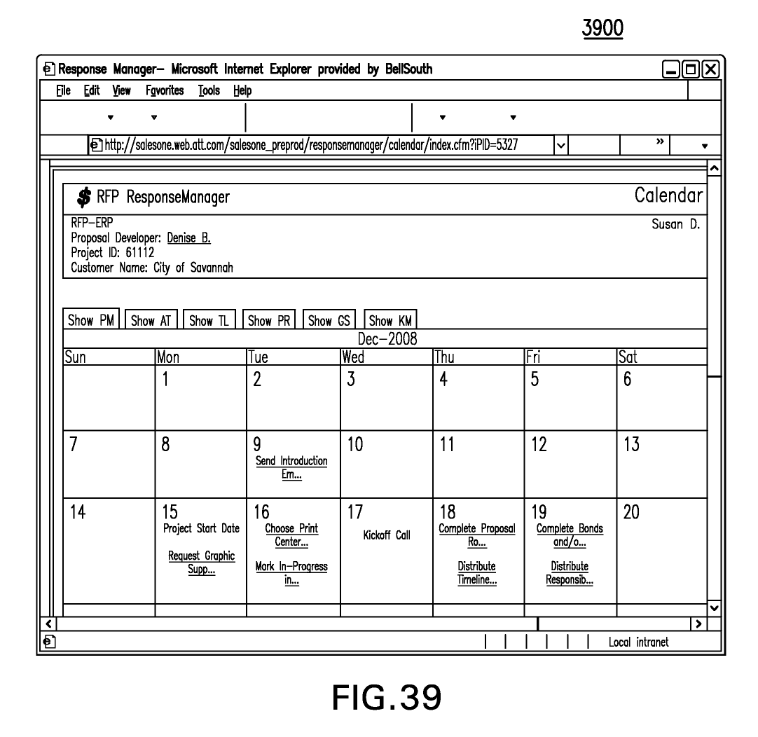

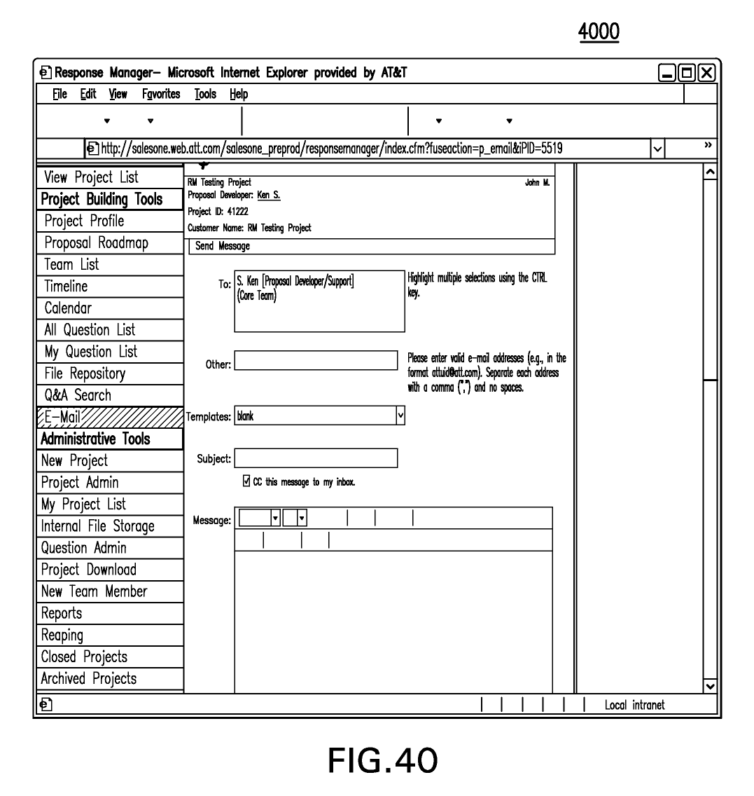

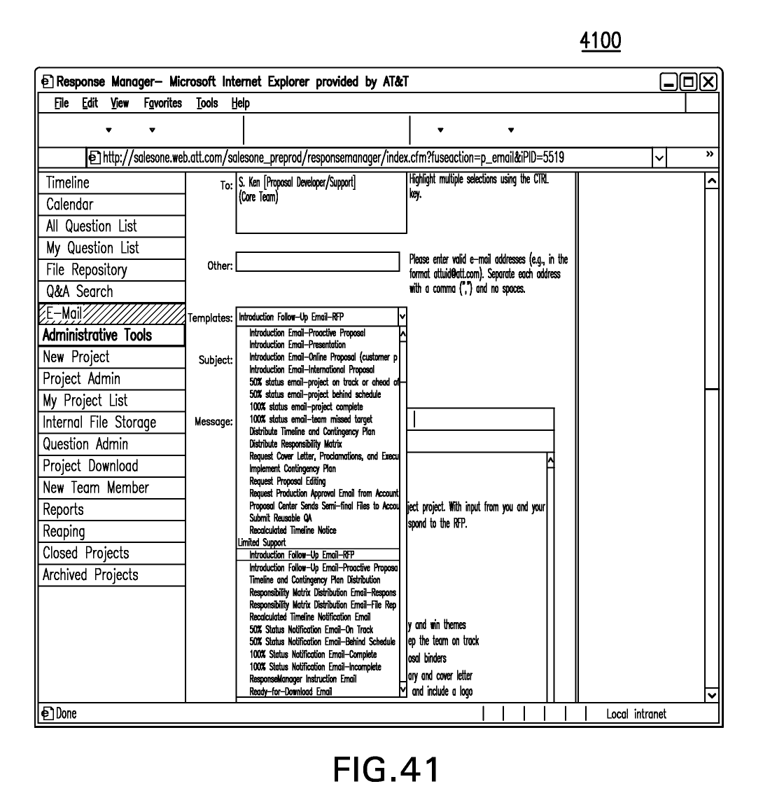

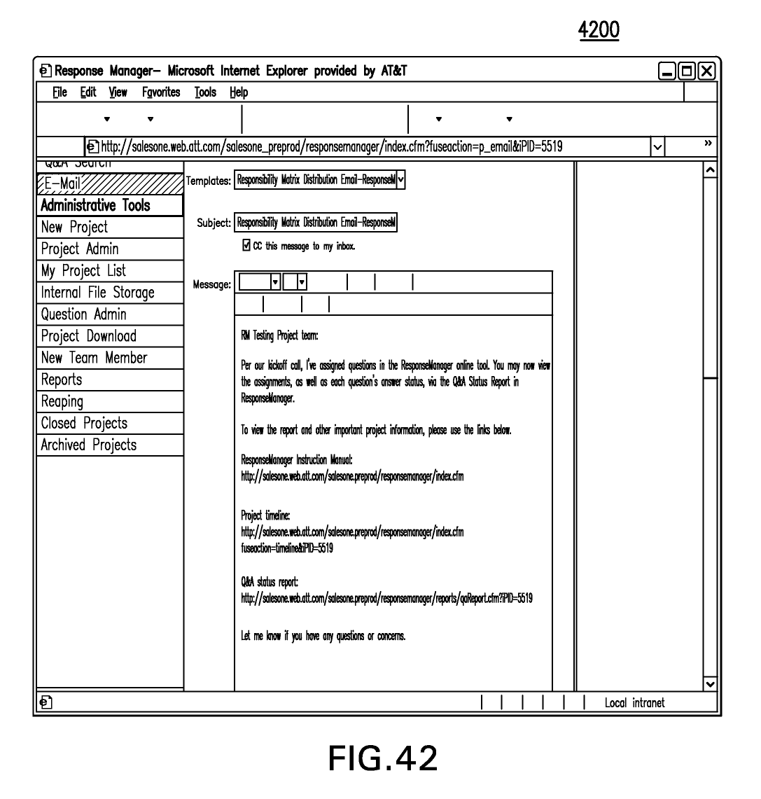

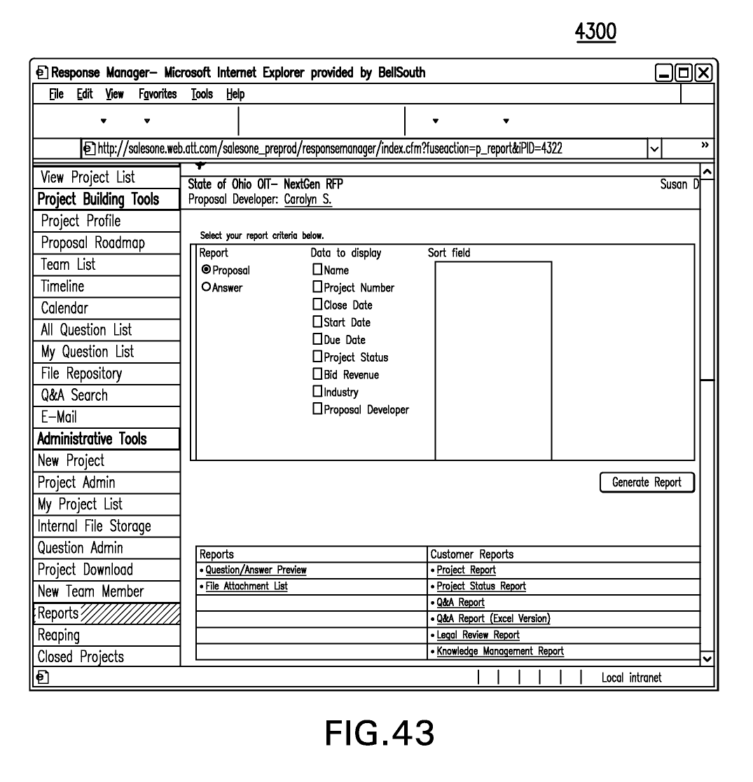

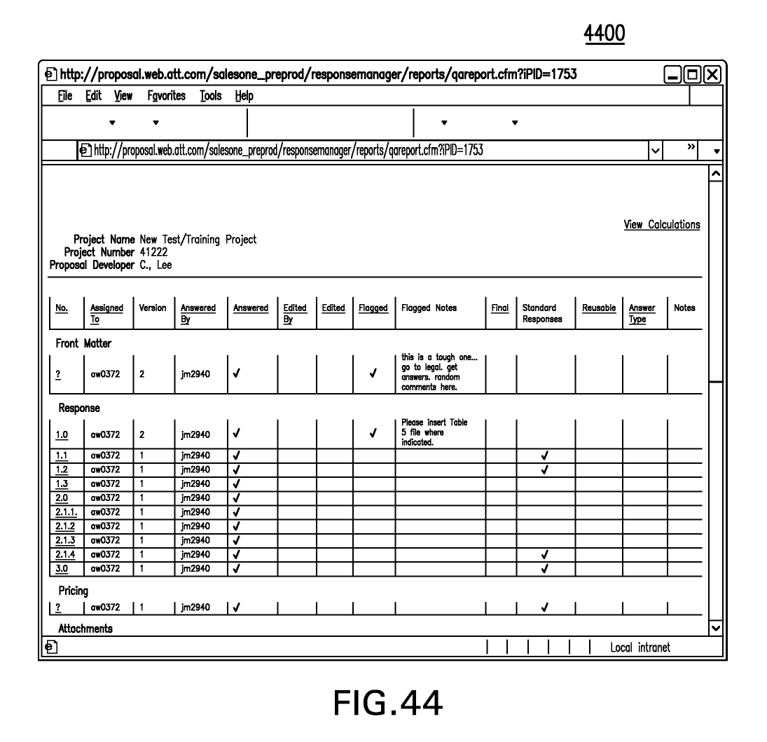

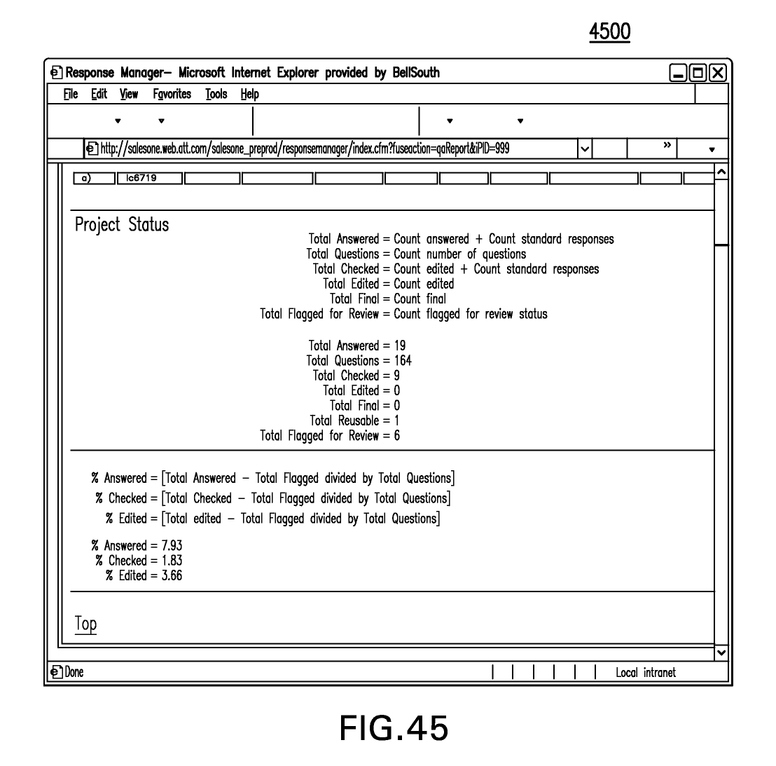

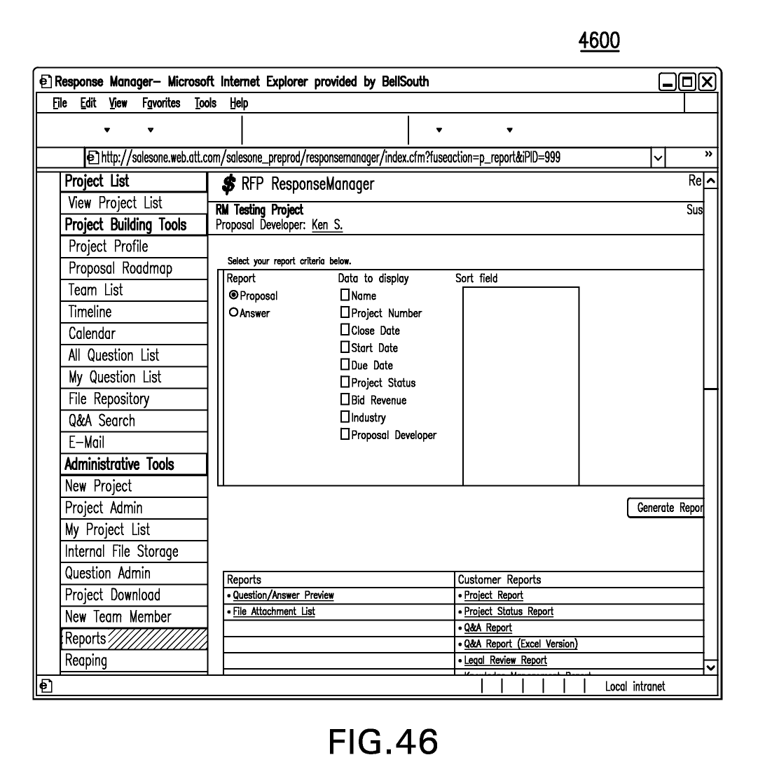

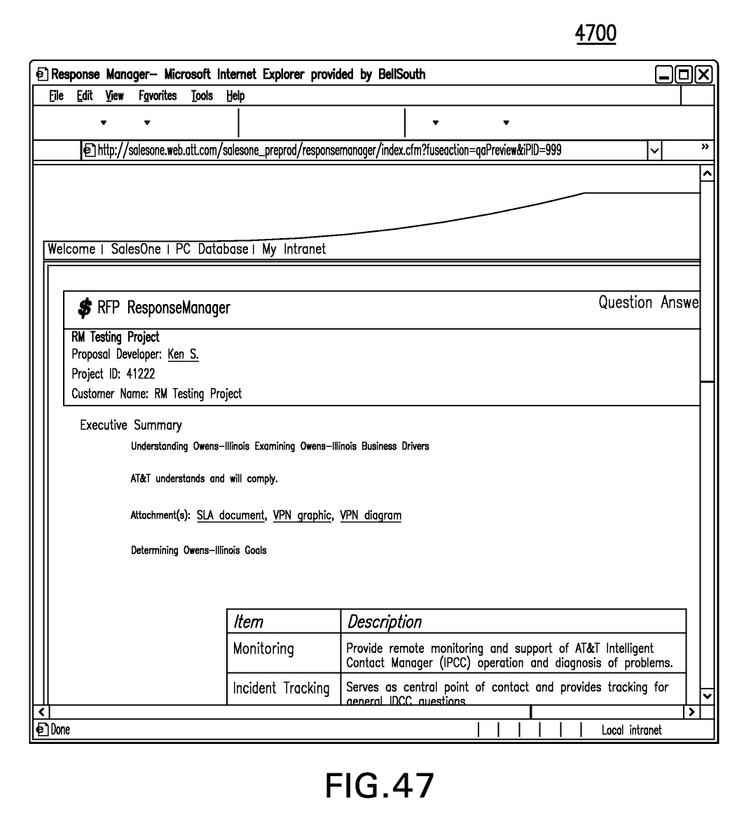

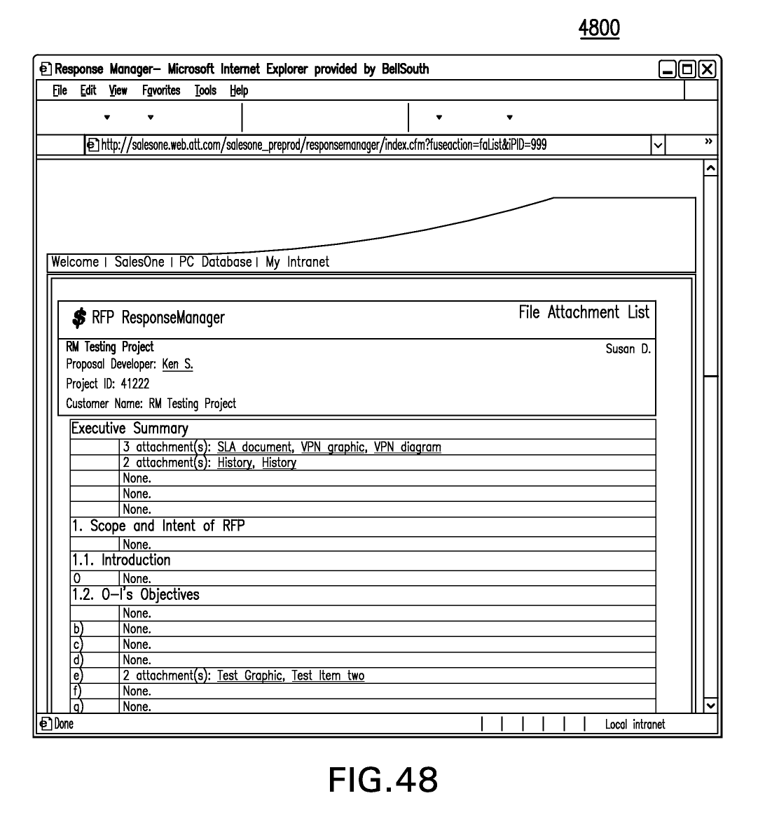

Referring to FIGS. 10-48, examples of Graphical User Interfaces (GUIs) are depicted that can be utilized with the methods of FIGS. 7-9. For simplicity the GUIs are described with respect to method 900, but it should be understood by one of ordinary skill in the art that the present disclosure contemplates use of the GUIs with other methods and techniques, including a portion of or all of methods 700 and 800, in addition to or in place of method 900. GUI 1000 depicts an RFP document that can be “parsed” by the techniques described herein to identify content. Parsing can include identifying headings, question text, and where an answer input will eventually be placed such as upon download into a Word or other word-processing file. GUI 1100 allows a user to access a web page for carrying out one or more of the steps of the exemplary methods. In one embodiment, a proposal manager can send a user the direct link to the user's project. In another embodiment, method 900 can provide for customizing the user's webpage. For instance, GUI 1100 allows clicking on the Get Widgets icon in the top left corner of the user's webpage, such as to add a Widget that will list all of the user's projects.

GUI 1200 allows a user to access the response manager page for carrying out one of more steps of method 900. For instance, a user can click on the Proposal Tools bar to access this screen and can scroll down the bar for RFP Response Tools then to the RFP response manager. In one embodiment, a user can double click to enter the tool. In another embodiment, this tool can be made available only in a controlled environment. For instance, use of the response manager can be limited to projects where a proposal developer has been assigned. GUI 1300 can be used as a welcome page for the response manager. The Project List icon can be selected to find a particular project. The welcome page can provide copies of training materials to new users of the system. For instance, a user can click on the plus sign to show and access various training materials. In one embodiment, GUI 1300 can post maintenance schedules for the response manager.

GUI 1400 provides a project list of all projects currently “live” in the response manager. “My Project List” can pare the list down to just those projects to which a user has been added as a team member. The project entry can have a link to allow access, show the due date for the project, and indicate the name of the assigned proposal developer. Simply click on the link to enter the project. In GUI 1500, navigation boxes to the left of the screen can allow a user to directly access various functions within the tool. For example, the first link can be the Project Profile link that provides summary or basic information about the project, such as due date, product sets, and content deadlines. The Proposal Manager's name can be listed at the top of the screen.

In GUI 1600, a question list screen can be used to access individual questions and show ownership. For instance, the All Question List can show all question items in the response manager. In one embodiment, the response manager can display questions in selected batch sizes, such as 100 per page. GUI 1600 can display the date and time that the item was answered along with the name of the person who provided input. In GUI 1700, the My Question List can display questions assigned to an identification indicia of the person logging into the response manager.

GUI 1800 allows for standard or pre-defined answer to be inserted through the use of drop-down boxes at the right of the screen. For example, a user may answer as many questions as he or she is capable of and then hit the Save button at the bottom of the screen to capture the responses. In one embodiment, a user can perform a mass update using standard or pre-defined answers by clicking on the boxes to the left of each question, selecting the standard answer from the drop-down menu and clicking on Mass Update. GUI 1900 allows custom answers to be inserted into the question items such as through the user clicking on the question link in the middle of the page to access. A user can view current answer content by passing the cursor over “View Q&A” to the left of each question item such that no clicking is necessary to view current content. In one embodiment, the answers are limited to text and cannot include graphics, but the present disclosure also contemplates inserting any form of data including graphics directly into these answers. In GUI 2000, a user can click on the Update Answer Text at the top of the screen to input his or her answer.

GUI 2100 depicts the text box for custom answer input. In one embodiment, the system can accept input typed or pasted into the box such as text or tables; however, pictures or graphics are attached as files for manual insertion into the final Word document. The present disclosure also contemplates inputting all formats of data, including pictures or graphics, directly into GUI 2100. In one embodiment, method 900 operates by allowing for users to “check out” various questions. The questions can then be “checked in” when the user is finished working with them. GUI 2200 depicts an answer as it was inserted into the resource manager and GUI 2300 depicts shows how a user can submit the answer as “version one.”

GUI 2400 allows items to be flagged within the resource manager for special attention. For instance, a user can check the box under attention items to mark an answer as flagged. In GUI 2500, comments or instructions can be typed into the Flagged Notes for attention. In GUI 2600, flagged items can be highlighted in yellow in the All Question List or My Question List views. In GUI 2700, flagged notes can be displayed in the project status report, which can be visible to all team members or to selected individuals. In GUI 2800, attachments can be uploaded into the resource manager via the answer page. A link can allow a user to browse the user's desktop. For instance, the resource manager can store the attachment and indicate it exists via a reporting feature as well as an icon on the answer screen. A user can click on the “Files: (Insert new)” bar to get started uploading a file.

In GUI 2900, the system can browse the user's desktop. A user can click on the Browse button to get started. A description of the attachment can be inputted to identify the content. In GUI 3000, the attachments can be uploaded into the resource manager. Attachments can be checked out for modification via the Check Out button at the right. A user can click on the Check Out button and download the file to the user's desktop. After the user has finished making modifications to the file, the user can click on the Check In button to return the file. The resource manager can track multiple versions of the attachment.

In GUI 3100, a File Repository can be provided which is a parking space for project files. Tabs can be inserted to assist in organization. Files can be uploaded in the same manner as is done for answer attachments. Files can be checked out for modification via the Check Out button at the right. The procedure can be the same as for working with attachment items. For instance, a user can click on “Check Out” to confirm a desire to check the item out, then right click the resulting screen to save the file to your desktop. A user can also save the file to a folder and modify the file as desired. A user can click on “Check In” to return the file. The system can automatically prompt the user for the file. In one embodiment, other users cannot modify a file as long as the file is checked out by the first user. The name of the person who has checked out a file can be displayed to other users until it is checked back in. Running the mouse over the “I” icon at the right of the attachment entry can show an informational box about the attachment. The user can see the name of the owner and when it was last updated.

In one embodiment, the File Repository allows the insertion of layout tabs and file sorting. This can help users to coherently organize project files to match their respective destinations in the final customer deliverable. For instance, a user can click on the Add New Tab at the top of the page to insert a new tab. The user can name the tab as desired. Files can be uploaded into the user's tabs by using the “Files: Insert New” command on the right side of the page. In one embodiment, files can be sorted within a tab by inserting a number (1, 2, 3, etc.) in front of the file at the left. The user can click Sort underneath the files to change the order in which they appear. Icons to the right of each file can allow deletion or movement to another tab within the File Repository.

In GUI 3200, projects can be locked to prohibit further answer input. Locking can be implemented so as to not impact the use of the file repository. Users can still access repository files for modification. Final project files can thus be parked in this spot for delivery to account teams. Users can see notification of locked status at the top of all pages within the response manager. In one embodiment, the name of the person that locked the project, as well as the date, time, and reason associated therewith, can be displayed.

In GUI 3300, a Proposal Roadmap can be made available for import by an account team, such as related to the strategic direction for the proposal. For instance, the Account Manager can work with the Account Executive or Sales Manager to complete and input this information. Use of the response manager to complete the information can allow the whole team to see the project notes. In GUI 3400, in order for the Roadmap information to be saved, the user can go the second page of the Roadmap and type text in the text box.

In GUI 3500, the Team List icon can reveal the names and contact numbers for all assigned account team members. In one embodiment, team members are added by the assigned proposal developer. In GUI 3600, a new timeline can be created. A user can click on the Create timeline button on a new project. The user can create a normal calendar for typical projects or a calendar where no printing is required. Also, there is can be an option for account team printing. In GUI 3700, on the timeline on the left side bar, a user can view various tasks for people within the Proposal Center, such as through a Proposal Manager View and an Account Team View. Other views can be provided for various groups within the Proposal Center. The calendar can automatically generate suggested dates for the Proposal Manager.

In GUI 3800, auto-populated calendar dates may be manually modified as the project needs change. Checkboxes to the left of the timeline tasks can enable managers to indicate when the task has been completed. In one embodiment, the response manager can capture names, dates, and times for task completion, thus automating team metrics. In GUI 3900, the calendar can allow users to quickly determine critical dates for their project. A user can click on the Calendar link in the navigation box to access the critical dates. In another embodiment, critical dates can be manually populated by the proposal developer. For example, tabs above the calendar can allow users to narrow the view to only tasks relevant to their function.

In GUI 4000, group emails and individual emails can be generated by any member of the project team through the Email function in the response manager. For example, the individual names can be highlighted for the email to be sent to them. In GUI 4100, templates can be provided for frequently utilized communications, for example, introductory emails. Template emails can be used to save time for users and ensure a homogenous level of service. A drop-down list of topics can be included in the Templates box within the response manager. In GUI 4200, template emails can be customized to address a wide audience. For instance, links at the bottom of the emails can direct users into project reporting, timeline, and response manager instruction pages.

In GUI 4300, a user can access the report via the “Reports” icon in the left navigation box. Reports can include various information such as Number, Assigned, and Answered to show project progress. Specialized reports can be generated by checking the boxes and actuating the Generate Reports button. In GUI 4400, an automated Q&A Report is shown. The report can allow the user to note obvious missing areas in the response for additional work. Content statistics can be shown at the bottom of the report. In GUI 4500, content statistics, such as the number answered, total questions, total edited, and the number flagged for review can be shown at the bottom of the report.

In GUI 4600, other reports can be made available on the menu. They can be found on the bottom middle of this screen: Question/Answer Preview; and Attachment report. In GUI 4700, the question/answer preview report lays out the entire response showing both questions and the answers that have been input. The report can also indicate whether or not attachment items have been uploaded for the various items. In GUI 4800, Attachment Reports can indicate where items have been uploaded to supplement or enhance answer input. Uploading attachment items into the response manager can eliminate misplaced items as well as the need to transfer large files via email. The user can view the uploaded attachments by clicking on them.

Upon reviewing the aforementioned embodiments, it would be evident to an artisan with ordinary skill in the art that said embodiments can be modified, reduced, or enhanced without departing from the scope and spirit of the claims described below. For example, the CMS 400 can be utilized for preparing responses to confidential or otherwise limited knowledge RFPs, such as those that provide limited information as to the specific tasks that are to be performed. The CMS 400 can review previous proposals generated based on these types of RFPs and adjust the proposals accordingly. Encryption or other confidentiality techniques can be performed by the CMS 400 for these types of RFPs.

In one embodiment, the CMS 400 can retrieve successful proposal information and build a database of proposal historical information. The CMS 400 can retrieve the information based on the type of RFP, such as generating Freedom of Information Act Requests for government RFPs and so forth.

Other suitable modifications can be applied to the present disclosure without departing from the scope of the claims below. Accordingly, the reader is directed to the claims section for a fuller understanding of the breadth and scope of the present disclosure.

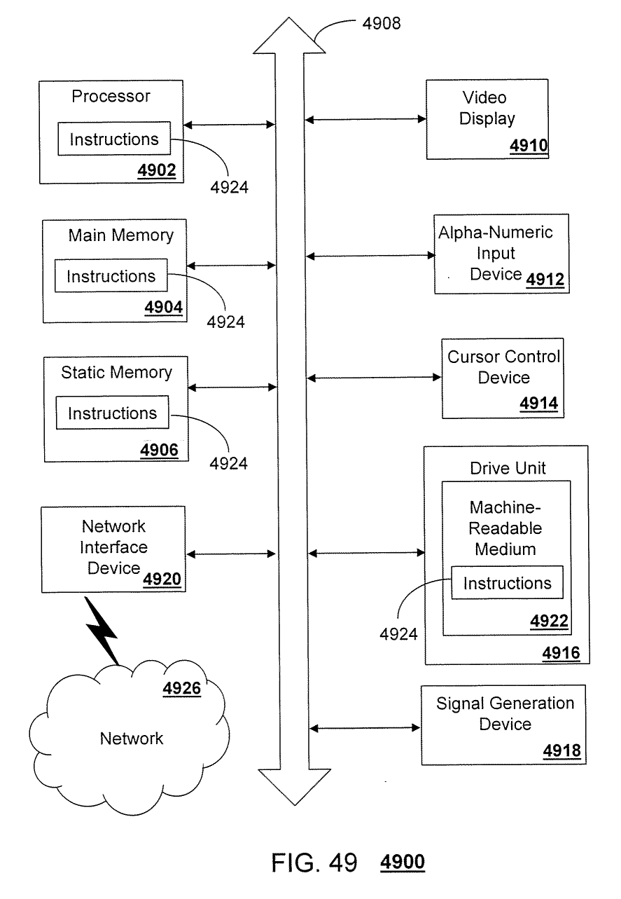

FIG. 49 depicts an exemplary diagrammatic representation of a machine in the form of a computer system 4900 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 4900 may include a processor 4902 (e.g., a central processing unit (CPU), a graphics processing unit (GPU, or both), a main memory 4904 and a static memory 4906, which communicate with each other via a bus 4908. The computer system 4900 may further include a video display unit 4910 (e.g., a liquid crystal display (LCD), a flat panel, a solid state display, or a cathode ray tube (CRT)). The computer system 4900 may include an input device 4912 (e.g., a keyboard), a cursor control device 4914 (e.g., a mouse), a disk drive unit 4916, a signal generation device 4918 (e.g., a speaker or remote control) and a network interface device 4920.

The disk drive unit 4916 may include a machine-readable medium 4922 on which is stored one or more sets of instructions (e.g., software 4924) embodying any one or more of the methodologies or functions described herein, including those methods illustrated above. The instructions 4924 may also reside, completely or at least partially, within the main memory 4904, the static memory 4906, and/or within the processor 4902 during execution thereof by the computer system 4900. The main memory 4904 and the processor 4902 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 4924, or that which receives and executes instructions 4924 from a propagated signal so that a device connected to a network environment 4926 can send or receive voice, video or data, and to communicate over the network 4926 using the instructions 4924. The instructions 4924 may further be transmitted or received over a network 4926 via the network interface device 4920.

While the machine-readable medium 4922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read -only (non-volatile) memories, random access memories, or other re-writable (volatile) memories; magneto-optical or optical medium such as a disk or tape. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions to:
retrieve a document comprising content corresponding to a questionnaire;
deconstruct the content in the document into a plurality of rhetorical content sections;
associate at least one rhetorical topic library with the content of each rhetorical content section according to a purpose of the content;
parse the content of each rhetorical content section into a combination of one or more rhetorical and structural elements according to the at least one rhetorical topic library associated with said content;
assign at least one combination of the one or more rhetorical and structural elements to at least one of a plurality of agents, continue the foregoing assignment until all combinations of the one or more rhetorical and structural elements have been assigned to at least one agent, wherein each agent is assigned to respond to the assigned combination;
manage the plurality of assignments as a project according to a project management procedure;
detect completion of at least one objective of the project according to the project management procedure; and
reconstruct the document according to responses provided by each agent associated with a corresponding combination of the one or more rhetorical and structural elements responsive to detecting the completion of the at least one objective.

2. The storage medium of claim 1, comprising computer instructions to store in a database each combination of the one or more rhetorical and structural elements.

3. The storage medium of claim 2, comprising computer instructions to:
receive an update performed by an assigned agent to at least one of the combinations of the one or more rhetorical and structural elements; and
store in the database the updated at least one combination of the one or more rhetorical and structural elements.

4. The storage medium of claim 3, comprising computer instructions to:
construct according to a rhetorical purpose a new combination of the one or more rhetorical and structural elements stored in the database;
repurpose the new combination of the one or more rhetorical and structural elements into a plurality of communication units; and
combine the plurality of communication units into a schematic expression.

5. The storage medium of claim 4, wherein the schematic expression corresponds to the reconstructed document.

6. The storage medium of claim 4, wherein each combination of the one or more rhetorical and structural elements is stored in the database with a functional attribute.

7. The storage medium of claim 6, comprising computer instructions to retrieve from the database the new combination of the one or more rhetorical and structural elements according to a comparison of the rhetorical purpose to the functional attribute of each combination of the one or more rhetorical and structural elements stored in the database.

8. The storage medium of claim 6, comprising computer instructions to:
search for one or more previously entered responses associated with other combinations of one or more rhetorical and structural elements having similar functional attributes to the functional attributes of the combinations of the one or more rhetorical and structural elements stored in the database; and
present at least one agent responses to other identified combinations of one or more rhetorical and structural elements having similar functional attributes.

9. The storage medium of claim 8, wherein at least a portion of the update performed by an assigned agent to at least one of the combinations of the one or more rhetorical and structural elements comprises a reuse of the one or more previously entered responses.

10. The storage medium of claim 1, wherein the plurality of agents comprises at least one of a human being and an artificial intelligence system.

11. The storage medium of claim 1, comprising computer instructions to submit one or more reports identifying a progress of the assigned agents in responding to the assigned combination.

12. The storage medium of claim 1, comprising computer instructions to submit one or more completion reminders to the assigned agents according to one or more milestones identified in the project management procedure.

13. The storage medium of claim 1, wherein the document corresponds to one of a request for proposal document and a training document.

14. A method, comprising:
deconstructing content in a document into a plurality of rhetorical content sections;
associating at least one rhetorical topic library with the content of each rhetorical content section according to the content's purpose;
parsing the content of each rhetorical content section into a combination of one or more rhetorical and structural elements according to the at least one rhetorical topic library associated with said content;
assigning at least one combination of the one or more rhetorical and structural elements to at least one of a plurality of agents, continue the foregoing assignment until all combinations of the one or more rhetorical and structural elements have been assigned to at least one agent, wherein each agent is assigned to respond to the assigned combination; and
managing the plurality of assignments as a project according to a project management procedure.

15. The method of claim 14, comprising:
detecting completion of at least one objective of the project according to the project management procedure; and
reconstructing the document according to responses provided by each agent associated with a corresponding combination of the one or more rhetorical and structural elements responsive to detecting the completion of the at least one objective.

16. The method of claim 14, comprising storing in a database each combination of the one or more rhetorical and structural elements.

17. The method of claim 16, comprising:
receiving an update performed by an assigned agent to at least one of the combinations of the one or more rhetorical and structural elements; and
storing in the database the updated at least one combination of the one or more rhetorical and structural elements.

18. The method of claim 17, comprising:
constructing according to a rhetorical purpose a new combination of the one or more rhetorical and structural elements stored in the database;
repurposing the new combination of the one or more rhetorical and structural elements into a plurality of communication units; and
combining the plurality of communication units into a schematic expression, wherein the schematic expression corresponds to the reconstructed document.

19. A method, comprising applying a project management procedure using a computing device to deconstructed content comprising a plurality of combinations of rhetorical and structural elements associated with at least one rhetorical topic library.

20. The method of claim 19, wherein the project management procedure comprises assigning a task to an entity and monitoring the task for completion.

21. A server, comprising a controller to:
deconstruct a document into a plurality of combinations of rhetorical and structural elements associated with at least one rhetorical topic library; and
apply a project management procedure to the plurality of combinations of rhetorical and structural elements associated with the rhetorical topic library.

22. A computer-readable storage medium, comprising computer instructions to:
retrieve a first document comprising content corresponding to a first Request For Proposal (RFP);
deconstruct the content into a plurality of rhetorical content sections;
associate at least one rhetorical topic library with the content of each rhetorical content section according to a purpose of the content;
parse the content of each rhetorical content section into a combination of one or more rhetorical and structural elements according to the at least one rhetorical topic library associated with said content; and
retrieve one or more second documents comprising other content associated with a second RFP, wherein the second documents are retrieved based on a comparison of the parsed content with the other content associated with the second RFP.

23. The storage medium of claim 22, wherein the one or more second documents are responses submitted for the second RFP.

24. The storage medium of claim 23, wherein the first document is associated with a first entity seeking an award of the first RFP, and wherein the responses are associated with a second entity that is different from the first entity.

25. The storage medium of claim 22, comprising computer instructions to:
store historical information comprising the responses; and
evaluate answers associated with the first RFP based on the historical information.
